(19) United States
(12) Patent Application Publication
(10) Pub. No.: US 2024/0340751 A1
(43) Pub. Date: Oct. 10, 2024

(54) METHOD AND DEVICE FOR MANAGING SECURITY KEY FOR PERFORMING CONTINUOUS CONDITIONAL PSCELL CHANGE IN NEXT-GENERATION MOBILE COMMUNICATION SYSTEM

(71) Applicant: Samsung Electronics Co., Ltd., Suwon-si (KR)

(72) Inventors: Seungri JIN, Suwon-si (KR); June HWANG, Suwon-si (KR); Hongjin CHOI, Suwon-si (KR)

(21) Appl. No.: 18/616,705

(22) Filed: Mar. 26, 2024

(30) Foreign Application Priority Data
Apr. 5, 2023 (KR) 10-2023-0044970

(51) Int. Cl. H04W 36/36; H04W 12/041

(52) U.S. Cl. CPC H04W 36/362; H04W 12/041

(57) ABSTRACT

The disclosure relates to a 5^{th} generation (5G) or 6^{th} generation (6G) communication system for supporting a higher data transmission rate. A method performed by a user equipment (UE) in a wireless communication system is provided. The method includes receiving, from a master node (MN), configuration information associated with subsequent conditional primary secondary cell group cell (PSCell) addition or change (SCPAC), the configuration information includes sk-counter list including a plurality of sk-counters, and executing the SCPAC for a first PSCell associated with a secondary node based on the configuration information, wherein a first security key for the secondary node is generated based on a first sk-counter among the plurality of sk-counters.

### CROSS-REFERENCE TO RELATED APPLICATION(S)

This application is based on and claims priority under 35 U.S.C. § 119 (a) of a Korean patent application number 10-2023-0044970, filed on Apr. 5, 2023, in the Korean Intellectual Property Office, the disclosure of which is incorporated by reference herein in its entirety.

### BACKGROUND

### 1. Field

The disclosure relates to a wireless communication system (or mobile communication system). More particularly, the disclosure relates to a method and a device for managing a security key for performing a continuous conditional primary secondary cell group cell (PSCell) change in a wireless communication system (or mobile communication system).

### 2. Description of Related Art

5^{th} generation (5G) mobile communication technology defines a wide frequency band to enable fast transmission speeds and new services, and includes sub-6 GHZ (‘Sub 6 GHz’) bands, such as 3.5 gigahertz (3.5 GHZ) as well as millimeter wave (mm) bands, such as 28 GHz and 39 GHz. It is also possible to implement it in the ultra-high frequency band (‘Above 6 GHz’) called Wave. In addition, in the case of 6^{th} generation (6G) mobile communication technology, which is called the system of Beyond 5G, Terra is working to achieve a transmission speed that is 50 times faster than 5G mobile communication technology and an ultra-low delay time that is reduced to one-tenth. Implementation in Terahertz bands (e.g., 95 GHz to 3 THz) is being considered.

In the early days of 5G mobile communication technology, there were concerns about ultra-wideband services (enhanced mobile broadband (eMBB)), ultra-reliable low-latency communications (URLLC), and massive machine-type communications (mMTC). With the goal of satisfying service support and performance requirements, efficient use of ultra-high frequency resources, including beamforming and massive array multiple input/output (massive MIMO) to alleviate radio wave path loss in ultra-high frequency bands and increase radio transmission distance. Various numerology support (multiple subcarrier interval operation, or the like) and dynamic operation of slot format, initial access technology to support multi-beam transmission and broadband, definition and operation of band-width part (BWP), large capacity new channel coding methods, such as low density parity check (LDPC) codes for data transmission and polar code for highly reliable transmission of control information, L2 pre-processing, and dedicated services specialized for specific services. Standardization of network slicing, or the like, which provides networks, has been carried out.

Currently, discussions are underway to improve and enhance the initial 5G mobile communication technology, considering the services that 5G mobile communication technology was intended to support, based on the vehicle's own location and status information. vehicle-to-everything (V2X) to help autonomous vehicles make driving decisions and increase user convenience, and new radio unlicensed (NR-U), which aims to operate a system that meets various regulatory requirements in unlicensed bands. New radio (NR) terminal low power consumption technology (user equipment (UE) power saving), non-terrestrial network (NTN), which is direct terminal-satellite communication to secure coverage in areas where communication with the terrestrial network is impossible, positioning, or the like. Physical layer standardization for technology is in progress.

In addition, integrated access and backhaul (IAB) provides a node for expanding the network service area by integrating intelligent factories (industrial Internet of things (IIoT)) to support new services through linkage and convergence with other industries, and wireless backhaul links and access links. Integrated Access and backhaul, mobility enhancement including conditional handover and dual active protocol stack (DAPS) handover, and 2-step random access (2-step random access channel (RACH) for standardization in the field of wireless interface architecture/protocol for technologies, such as NR) is also in progress, and a 5G baseline for incorporating network functions virtualization (NFV) and software-defined networking (SDN) technology standardization in the field of system architecture/services for architecture (e.g., service based architecture, service based interface) and mobile edge computing (MEC), which provides services based on the location of the terminal, is also in progress.

When this 5G mobile communication system is commercialized, an explosive increase in connected devices will be connected to the communication network. Accordingly, it is expected that strengthening the functions and performance of the 5G mobile communication system and integrated operation of connected devices will be necessary. To this end, extended reality (XR) and artificial intelligence are designed to efficiently support augmented reality (AR), virtual reality (VR), and mixed reality (MR), artificial intelligence (AI) and machine learning (ML), new research will be conducted on 5G performance improvement and complexity reduction, AI service support, metaverse service support, and drone communication.

In addition, the development of these 5G mobile communication systems includes new waveforms, full dimensional MIMO (FD-MIMO), and array antennas to ensure coverage in the terahertz band of 6G mobile communication technology, multi-antenna transmission technology, such as large scale antenna, metamaterial-based lens and antenna to improve coverage of terahertz band signals, high-dimensional spatial multiplexing technology using orbital angular momentum (OAM), reconfigurable intelligent surfaces (RIS) (in addition to reconfigurable intelligent surface technology, full duplex technology, satellite, and artificial intelligence (AI) to improve the frequency efficiency of 6G mobile communication technology and system network are utilized from the design stage and end-to-end, -to-end) development of AI-based communication technology that realizes system optimization by internalizing AI support functions, and next-generation distributed computing technology that realizes services of complexity beyond the limits of terminal computing capabilities by utilizing ultra-high-performance communication and computing resources.

As various services can be provided as described above and with the development of mobile communication systems, there is a need for a method to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure are to provide a device and a method capable of efficiently providing services in a mobile communication system.

Additional aspects will be set forth in part in the description which follows and, in part, will be apparent from the description, or may be learned by practice of the presented embodiments.

In accordance with an aspect of the disclosure, a method performed by a user equipment (UE) in a wireless communication system is provided. The method includes receiving, from a master node (MN), configuration information associated with subsequent conditional primary secondary cell group cell (PSCell) addition or change (SCPAC), the configuration information includes sk-counter list including a plurality of sk-counters, and executing the SCPAC for a first PSCell associated with a secondary node based on the configuration information, wherein a first security key for the secondary node is generated based on a first sk-counter among the plurality of sk-counters.

In accordance with another aspect of the disclosure, a UE in a wireless communication system is provided. The UE includes a transceiver, memory storing one or more computer programs, and one or more processors communicatively coupled to the transceiver and the memory, wherein the one or more computer programs include computer-executable instructions that, when executed by the one or more processors, cause the UE to receive, from an MN, configuration information associated with SCPAC, the configuration information includes sk-counter list including a plurality of sk-counters, and execute the SCPAC for a first PSCell associated with a secondary node based on the configuration information, wherein a first security key for the secondary node is generated based on a first sk-counter among the plurality of sk-counters.

In accordance with another aspect of the disclosure, one or more non-transitory computer-readable storage media storing computer-executable instructions that, when executed by one or more processors of a user equipment (UE), cause the UE to perform operations are provided. The operations include receiving, from a master node (MN), configuration information associated with subsequent conditional primary secondary cell group cell (PSCell) addition or change (SCPAC), the configuration information includes sk-counter list including a plurality of sk-counters, and executing the SCPAC for a first PSCell associated with a secondary node based on the configuration information, wherein a first security key for the secondary node is generated based on a first sk-counter among the plurality of sk-counters.

Another aspect of the disclosure is to provide a device and a method for efficiently providing services in a mobile communication system.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a typical long term evolution (LTE) system according to an embodiment of the disclosure;

FIG. 2 is a diagram illustrating a radio protocol structure of a typical LTE system according to an embodiment of the disclosure;

FIG. 3 is a diagram illustrating a structure of a next-generation mobile communication system according to an embodiment of the disclosure;

FIG. 4 is a diagram illustrating a radio protocol structure of a next-generation mobile communication system according to an embodiment of the disclosure;

FIG. 5 is a diagram illustrating an operation of configuring a security key when dual connectivity (DC) is configured in an LTE system or a new radio (NR) system according to an embodiment of the disclosure;

FIG. 6 is a diagram illustrating overall operations of performing a conditional primary secondary cell group cell (PSCell) change procedure in an LTE system or an NR system according to an embodiment of the disclosure;

FIG. 7 is a diagram illustrating a part of overall operations of continuously performing a conditional PSCell addition and change procedure according to an embodiment of the disclosure;

FIG. 8 is a diagram illustrating remaining parts of overall operations of continuously performing a conditional PSCell addition and change procedure according to an embodiment of the disclosure;

FIG. 9 is a diagram illustrating a scenario for improving an operation of configuring and maintaining a security key according to an embodiment of the disclosure;

FIG. 10 is a diagram illustrating a security configuration procedure applied to a candidate PSCell in a continuous conditional PSCell addition and change procedure according to an embodiment of the disclosure;

FIG. 11 is a diagram specifying a terminal operation when conditional PSCell addition and changes are continuously applied, as a terminal operation according to an embodiment of the disclosure;

FIG. 12 is a diagram specifying a base station operation when conditional PSCell addition and changes are continuously applied, as a base station operation according to an embodiment of the disclosure;

FIG. 13 is a block diagram illustrating an internal structure of a terminal according to an embodiment of the disclosure; and

FIG. 14 is a block diagram illustrating a configuration of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For the same reason, some components in the attached drawings are exaggerated, omitted, or schematically shown. Additionally, the size of each component does not entirely reflect its actual size. In each drawing, identical or corresponding components are assigned the same reference numbers.

The advantages and features of the disclosure and methods for achieving them will become clear by referring to the embodiments described below along with the accompanying drawings. However, the disclosure is not limited to the embodiments disclosed below and may be implemented in various different forms, and the embodiments are merely intended to ensure that the disclosure is complete and to provide common knowledge in the technical field to which the disclosure pertains. It is provided to fully inform those who have the scope of the disclosure, and the disclosure is only defined by the scope of the claims. Like reference numerals refer to like elements throughout the disclosure.

At this time, it will be understood that each block of the processing flow diagrams and combinations of the flow diagram diagrams can be performed by computer program instructions. These computer program instructions can be mounted on a processor of a general-purpose computer, special-purpose computer, or other programmable data processing equipment, so that the instructions performed through the processor of the computer or other programmable data processing equipment are described in the flow chart block(s). It creates the means to perform functions. These computer program instructions may also be stored in computer-usable or computer-readable memory that can be directed to a computer or other programmable data processing equipment to implement a function in a particular manner, so that the computer-usable or computer-readable memory It is also possible to produce manufactured items containing instruction means that perform the functions described in the flowchart block(s). Computer program instructions can also be mounted on a computer or other programmable data processing equipment, so that a series of operational are performed on the computer or other programmable data processing equipment to create a process that is executed by the computer, thereby generating a process that is executed by the computer or other programmable data processing equipment. Instructions that perform processing equipment may also provide operations for executing the functions described in the flow diagram block(s).

Additionally, each block may represent a module, segment, or portion of code that includes one or more executable instructions for executing specified logical function(s). Additionally, it should be noted that in some alternative execution examples it is possible for the functions mentioned in the blocks to occur out of order. For example, it is possible for two blocks shown in succession to be performed substantially simultaneously, or it is possible for the blocks to be performed in reverse order depending on the corresponding function.

At this time, the term ‘˜unit’ used in this embodiment refers to software or hardware components, such as field programmable gate array (FPGA) or application specific integrated circuit (ASIC), and ‘˜unit’ performs certain roles. However, ‘˜part’ is not limited to software or hardware. The ‘˜ part’ may be configured to reside in an addressable storage medium and may be configured to reproduce on one or more processors. Therefore, as an example, ‘˜ part’ refers to components, such as software components, object-oriented software components, class components, and task components, processes, functions, properties, and procedures, subroutines, segments of program code, drivers, firmware, microcode, circuitry, data, databases, data structures, tables, arrays, and variables. The functions provided within the components and ‘parts’ may be combined into a smaller number of components and ‘parts’ or may be further separated into additional components and ‘parts’. Additionally, components and ‘parts’ may be implemented to regenerate one or more central processing units (CPUs) within a device or a secure multimedia card. In addition, in an embodiment, ‘˜ part’ may include one or more processors.

In the following description of the disclosure, if a detailed description of a related known function or configuration is determined to unnecessarily obscure the gist of the disclosure, the detailed description will be omitted. Hereinafter, embodiments of the disclosure will be described with reference to the attached drawings.

Terms used in the following description to identify a connection node, a term referring to network entities, a term referring to messages, a term referring to an interface between network objects, and a term referring to various types of identification information. The following are examples for convenience of explanation. Accordingly, the disclosure is not limited to the terms described later, and other terms referring to objects having equivalent technical meaning may be used.

Hereinafter, the base station is the entity that performs resource allocation for the terminal and may be at least one of gNode B, eNode B, Node B, base station (BS), wireless access unit, base station controller, or node on the network. A terminal may include a user equipment (UE), a mobile station (MS), a cellular phone, a smartphone, a computer, or a multimedia system capable of performing communication functions. Of course, the base station and terminal are not limited to the above examples. In this disclosure, downlink (DL) refers to a wireless transmission path of a signal transmitted from a base station to a terminal, and uplink (UL) refers to a wireless transmission path of a signal transmitted from a terminal to a base station.

Wireless communication systems have moved away from providing early voice-oriented services to, for example, 3^{rd} generation partnership project (3GPP)'s high speed packet access (HSPA), long term evolution (LTE) or evolved universal terrestrial radio access (E-UTRA), and LTE-advanced (LTE-A). Broadband wireless that provides high-speed, high-quality packet data services, such as communication standards, such as LTE-A, LTE-Pro, 3GPP2's high rate packet data (HRPD), ultra mobile broadband (UMB), and institute of electrical and electronics engineers (IEEE)'s 802.16e. It is evolving into a communication system.

As a future communication system after LTE, that is, the 5G communication system must be able to freely reflect the various requirements of users and service providers, so services that simultaneously satisfy various requirements must be supported. Services considered for the 5G communication system include enhanced mobile broadband (eMBB), massive machine type communication (mMTC), and ultra reliability low latency communication (URLLC). There is.

According to some embodiments, eMBB may aim to provide more improved data transmission rates than those supported by existing LTE, LTE-A, or LTE-Pro. For example, in a 5G communication system, eMBB must be able to provide a peak data rate of 20 Gbps in the downlink and 10 Gbps in the uplink from the perspective of one base station. In addition, the 5G communication system may need to provide the maximum transmission rate and at the same time provide an increased user perceived data rate. In order to meet these requirements, 5G communication systems may require improvements in various transmission and reception technologies, including more advanced multi-antenna (multi input multi output (MIMO) transmission technology. In addition, while the current LTE transmits signals using a maximum of 20 MHz transmission bandwidth in the 2 GHz band, the 5G communication system uses a frequency bandwidth wider than 20 MHz in the 3 to 6 GHz or above 6 GHz frequency band, meeting the requirements of the 5G communication system. Data transfer speed can be satisfied.

At the same time, mMTC is being considered to support application services, such as Internet of things (IoT) in 5G communication systems. In order to efficiently provide the Internet of Things, mMTC may require support for access to a large number of terminals within a cell, improved coverage of terminals, improved battery time, and reduced terminal costs. Since the Internet of Things provides communication functions by attaching various sensors and various devices, it must be able to support a large number of terminals (for example, 1,000,000 terminals/km2) within a cell. Additionally, due to the nature of the service, terminals supporting mMTC are likely to be located in shaded areas that cannot be covered by cells, such as the basement of a building, so wider coverage may be required compared to other services provided by the 5G communication system. Terminals that support mMTC must include low-cost terminals, and because it is difficult to frequently replace the terminal's battery, a very long battery life time, such as 10 to 15 years, may be required.

Lastly, in the case of URLLC, it is a cellular-based wireless communication service used for specific purposes (mission-critical), such as remote control of robots or machinery, industrial automation, It can be used for services, such as unmanned aerial vehicles, remote health care, and emergency alerts. Therefore, the communication provided by URLLC may need to provide very low latency (ultra-low latency) and very high reliability (ultra-reliability). For example, a service supporting URLLC must satisfy an air interface latency of less than 0.5 milliseconds and may have a packet error rate of less than 10-5. Therefore, for services supporting URLLC, the 5G system (5GS) must provide a smaller transmit time interval (TTI) than other services, and at the same time, a design that requires allocating wide resources in the frequency band to ensure the reliability of the communication link. Specifications may be required.

The three services considered in the above-described 5G communication system, namely eMBB, URLLC, and mMTC, can be multiplexed and transmitted in one system. At this time, different transmission/reception techniques and transmission/reception parameters can be used between services to satisfy the different requirements of each service. However, the above-described mMTC, URLLC, and eMBB are only examples of different service types, and the service types to which this disclosure is applied are not limited to the above-described examples.

In addition, this disclosure may be applied to other communication systems through some modifications without significantly departing from the scope of the disclosure at the discretion of a person with skilled technical knowledge. At this time, it will be understood that each block of the processing flow diagram diagrams and combinations of the flow diagram diagrams can be performed by computer program instructions.

These computer program instructions can be mounted on a processor of a general-purpose computer, special-purpose computer, or other programmable data processing equipment, so that the instructions performed through the processor of the computer or other programmable data processing equipment are described in the flow chart block(s). It creates the means to perform functions. These computer program instructions may also be stored in computer-usable or computer-readable memory that can be directed to a computer or other programmable data processing equipment to implement a function in a particular manner, so that the computer-usable or computer-readable memory It is also possible to produce manufactured items containing instruction means that perform the functions described in the flowchart block(s). Computer program instructions can also be mounted on a computer or other programmable data processing equipment, so that a series of operations are performed on the computer or other programmable data processing equipment to create a process that is executed by the computer, thereby generating a process that is executed by the computer or other programmable data processing equipment. Instructions that perform processing equipment may also provide operations for executing the functions described in the flow diagram block(s).

Additionally, each block may represent a module, segment, or portion of code that includes one or more executable instructions for executing specified logical function(s). Additionally, it should be noted that in some alternative execution examples it is possible for the functions mentioned in the blocks to occur out of order. For example, it is possible for two blocks shown in succession to be performed substantially simultaneously, or it is possible for the blocks to be performed in reverse order depending on the corresponding function. At this time, the term ‘˜unit’ used in this embodiment refers to software or hardware components, such as field programmable gate array (FPGA) or application specific integrated circuit (ASIC), and ‘˜unit’ refers to what roles. It can be done. However, ‘˜part’ is not limited to software or hardware. The ‘˜ part’ may be configured to reside in an addressable storage medium and may be configured to reproduce on one or more processors. Therefore, as an example, ‘˜ part’ refers to components, such as software components, object-oriented software components, class components, and task components, processes, functions, properties, and procedures, subroutines, segments of program code, drivers, firmware, microcode, circuitry, data, databases, data structures, tables, arrays, and variables. The functions provided within the components and ‘parts’ may be combined into a smaller number of components and ‘parts’ or may be further separated into additional components and ‘parts’. Additionally, components and ‘parts’ may be implemented to regenerate one or more CPUs within a device or a secure multimedia card. Additionally, in an embodiment, ‘˜ part’ may include one or more processors.

For convenience of description below, this disclosure uses terms and names defined in the 5GS and NR standards, which are standards defined by the 3^{rd} generation partnership project (3GPP) organization among currently existing communication standards. However, the disclosure is not limited by the above terms and names, and may be equally applied to wireless communication networks complying with other standards. For example, the disclosure can be applied to 3GPP 5GS/NR (5^{th} generation mobile communication standard). The disclosure relates to an improvement technique for a conditional primary secondary cell group (SCG) cell (PSCell) addition and change (CPA and CPC; CPAC) applied to an existing NR system, wherein, after a secondary cell group (SCG) is changed, all candidate SCG configurations stored in a terminal are released, so that continuous CPAC operation is impossible. For example, once a CPAC is applied and performed, in order to perform the CPAC operation again, a base station needs to grant a CPAC configuration again via a radio resource control (RRC) configuration. In addition, since a scenario in which a CPA is configured and a scenario in which a CPC is configured are different from each other, and there is no case where a CPA and a CPC are concurrently configured, CPA and CPC configurations had to be separately configured depending on whether a terminal applies dual connectivity (hereinafter, DC).

According to a continuous CPAC support method proposed in the disclosure, a base station may provide a terminal with a candidate SCG configuration and indication for a continuous CPAC so as to enable the terminal to keep a corresponding configuration even after changing of the SCG configuration, and the base station may support a continuous CPAC operation according to a channel state, or the like, without an additional RRC configuration, so that unnecessary RRC signaling may be reduced, and a dynamic CPAC operation according to the channel state may be performed. In particular, configurations related to a CPC and a CPA (conditions for the CPC and CPA, and configurations applied after handover) may be transferred to a terminal and managed simultaneously, and therefore the number of additional RRC configurations may be reduced.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

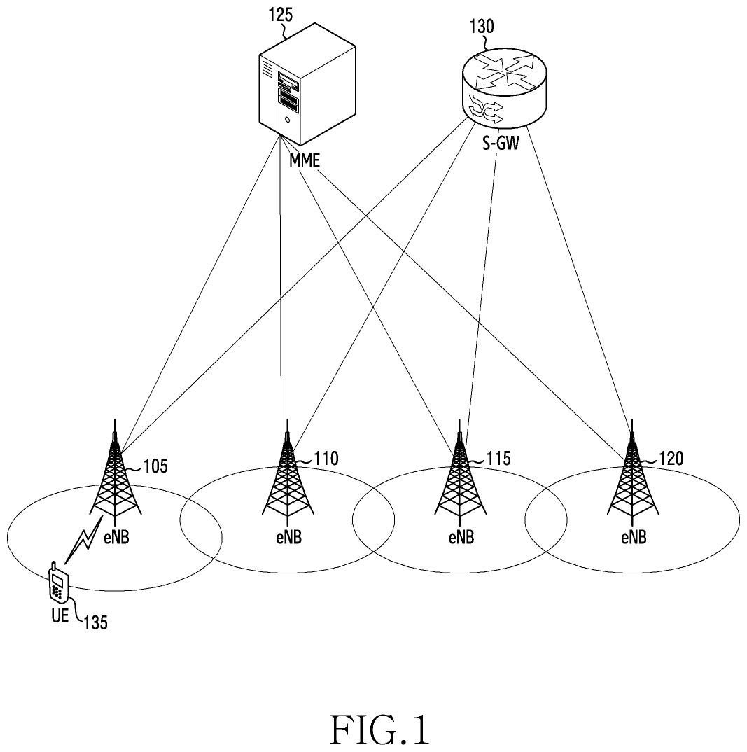

FIG. 1 illustrates a structure of a typical LTE system according to an embodiment of the disclosure.

Referring to FIG. 1, as illustrated therein, a radio access network of an LTE system may include next-generation base stations (referred to as evolved node Bs, hereinafter eNBs, node Bs, or base stations) 105, 110, 115, and 120, a mobility management entity (MME) 125, and a serving gateway (S-GW) 130. A user equipment (hereinafter UE or terminal) 135 may access an external network through the eNBs 105, 110, 115, and 120 and the S-GW 130.

Referring to FIG. 1, the eNBs 105, 110, 115, and 120 may correspond to node Bs of the related art of a universal mobile telecommunication system (UMTS). The eNBs may be connected to the UE 135 through a radio channel, and perform more complicated roles than the node Bs of the related art. In the LTE system, since all user traffic including real-time services, such as voice over IP (VOIP) via the Internet protocol, is serviced through a shared channel, a device that collects state information, such as buffer states, available transmit power states, and channel states of UEs, and performs scheduling accordingly is required, and the eNBs 105, 110, 115, and 120 may serve as the device. In general, one eNB may control multiple cells. For example, in order to implement a transfer rate of 100 Mbps, the LTE system may use orthogonal frequency division multiplexing (hereinafter referred to as OFDM) as a radio access technology in a bandwidth of, for example, 20 MHz. In addition, the LTE system may employ an adaptive modulation & coding (hereinafter referred to as AMC) scheme for determining a modulation scheme and a channel coding rate according to the channel state of a UE. The S-GW 130 is a device that provides a data bearer, and may generate or remove a data bearer under the control of the MME 125. The MME 125 is responsible for various control functions as well as a mobility management function for a UE, and may be connected to multiple base stations.

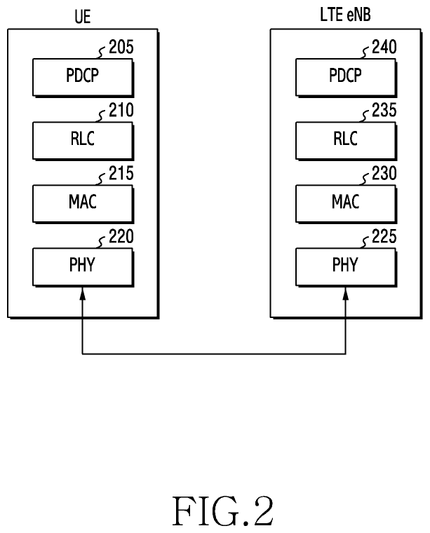

FIG. 2 illustrates a radio protocol structure in a typical LTE system according to an embodiment of the disclosure.

Referring to FIG. 2, a radio protocol of an LTE system includes a packet data convergence protocol (PDCP) 205 or 240, a radio link control (RLC) 210 or 235, and a medium access control (MAC) 215 or 230 in each of a UE and an eNB. The PDCP 205 or 240 serves to perform operations, such as IP header compression/reconstruction. The main functions of the PDCP 205 or 240 may be summarized as follows. The PDCP is not limited by the following functions and may perform various functions.
Header compression and decompression (robust header compression (ROHC) only)
Transfer of user data
In-sequence delivery (in-sequence delivery of upper layer protocol data units (PDUs) at PDCP re-establishment procedure for RLC acknowledged mode (AM))
Reordering (for split bearers in DC (only support for RLC AM): PDCP PDU routing for transmission and PDCP PDU reordering for reception)
Duplicate detection (duplicate detection of lower layer service data units (SDUs) at PDCP re-establishment procedure for RLC AM)
Retransmission (retransmission of PDCP SDUs at handover and, for split bearers in DC, of PDCP PDUs at PDCP data-recovery procedure, for RLC AM)
Ciphering and deciphering
Timer-based SDU discard (timer-based SDU discard in uplink)

The radio link control (hereinafter referred to as RLC) 210 or 235 may reconfigure a PDCP protocol data unit (PDU) into an appropriate size to perform an automatic repeat request (ARQ) operation. The main functions of the RLC may be summarized as follows. The RLC is not limited by the following functions and may perform various functions.
Data transfer (transfer of upper layer PDUs)
ARQ (Error Correction through ARQ (only for AM data transfer))
Concatenation, segmentation and reassembly (concatenation, segmentation and reassembly of RLC SDUs (only for UM and AM data transfer))
Re-segmentation (re-segmentation of RLC data PDUs (only for AM data transfer))
Reordering (reordering of RLC data PDUs (only for UM and AM data transfer))
Duplicate detection (only for UM and AM data transfer)
Error detection (protocol error detection (only for AM data transfer))
RLC SDU discard (only for UM and AM data transfer)
RLC re-establishment

The MAC 215 or 230 is connected to several RLC layer devices configured in a single terminal, and multiplexes RLC PDUs to a MAC PDU and demultiplexes a MAC PDU to RLC PDUs. The main functions of the MAC are summarized as follows. The MAC is not limited by the following functions and may perform various functions.
Mapping (mapping between logical channels and transport channels)
Multiplexing and demultiplexing (multiplexing/demultiplexing of MAC SDUs belonging to one or different logical channels into/from transport blocks (TB) delivered to/from the physical layer on transport channels)
Scheduling information reporting
Hybrid ARQ (HARQ) (error correction through HARQ)
Priority handling between logical channels (priority handling between logical channels of one UE)
Priority handling between UEs (priority handling between UEs by means of dynamic scheduling)
Multimedia broadcast and multicast service (MBMS) service identification
Transport format selection
Padding

A physical (PHY) layer 220 or 225 may perform channel coding and modulation of higher layer data, make the data into OFDM symbols, and transmit the OFDM symbols through a wireless channel, or perform demodulation and channel decoding of OFDM symbols received through a wireless channel and then transfer the OFDM symbols to a higher layer. For additional error correction, the PHY layer may also use hybrid ARQ (HARQ), and a receiving end may use one bit to transmit whether a packet transmitted by a transmitting end is received. This may be referred to as HARQ ACK/NACK information. HARQ ACK/NACK information in response to uplink transmission may be transmitted through a physical hybrid-ARQ indicator channel (PHICH), and HARQ ACK/NACK information in response to downlink transmission may be transmitted through a physical uplink control channel (PUCCH) or physical uplink shared channel (PUSCH). The PHY layer is not limited by these functions and may perform various functions.

The PHY layer may include one or multiple frequencies/carriers, and a technology for simultaneously configuring and using multiple frequencies may be referred to as carrier aggregation (hereinafter CA). The CA refers to a technology in which, instead of using only one carrier for communication between a UE and an E-UTRAN node B (eNB), one primary carrier and multiple secondary carriers are additionally used and thus data capacity may be greatly increased as much as the number of secondary carriers. In LTE, a cell in an eNB using the primary carrier may be referred to as a primary cell (PCell) and a cell in an eNB using the secondary carrier may be referred to as a secondary cell (SCell).

Although not illustrated, radio resource control (hereinafter RRC) layers may exist as higher layers than the PDCP layers of the UE and the eNB, respectively, and for radio resource control, the RRC layers may exchange configuration control messages related to access and measurement.

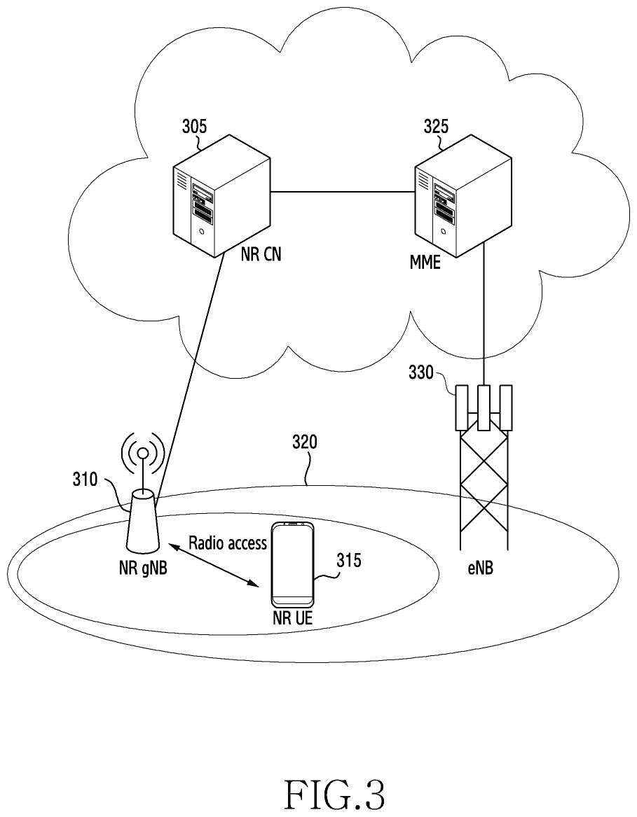

FIG. 3 illustrates a structure of a next-generation mobile communication system according to an embodiment of the disclosure.

Referring to FIG. 3, as illustrated therein, a radio access network of a next-generation mobile communication system may include a next-generation base station (new radio node B, hereinafter NR gNB) 310, and a new radio core network (NR CN) or next generation core network (NG CN) 305. A user terminal (new radio user equipment, hereinafter NR UE or NR terminal) 315 accesses an external network via the NR gNB 310 and the NR CN 305.

Referring to FIG. 3, the NR gNB 310 may correspond to an evolved node B (eNB) 330 of an LTE system of the related art. The NR gNB 310 is connected to the NR UE 315 through a radio channel and may provide outstanding services as compared to a node B of the related art. In the next-generation mobile communication system, since all user traffic is serviced through a shared channel, a device that collects state information, such as buffer statuses, available transmit power states, and channel states of UEs, and performs scheduling accordingly, and the NR NB 310 may serve as the device. In general, one NR gNB 310 may control multiple cells. In order to implement ultrahigh-speed data transfer beyond the current LTE, the next-generation mobile communication system may provide a wider bandwidth than the existing maximum bandwidth, may employ an orthogonal frequency division multiplexing (hereinafter referred to as OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE. The NR CN 305 may perform functions, such as mobility support, bearer configuration, and quality of service (QOS) configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 325 via a network interface. The MME 325 may be connected to an eNB 330 that is an existing base station in a network 320.

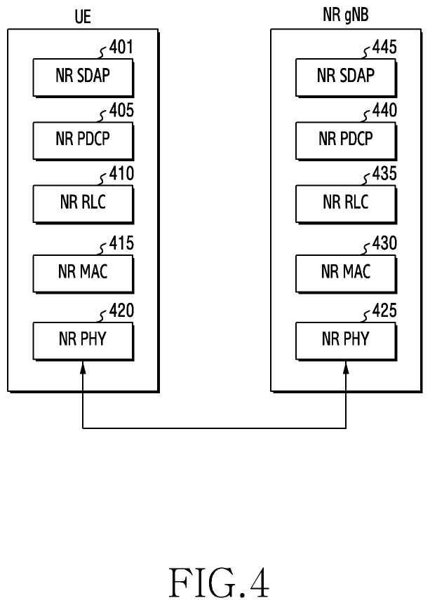

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 401 or 445, an NR PDCP 405 or 440, an NR RLC 410 or 435, and an NR MAC 415 or 430 in each of a UE and an NR base station.

The main functions of the NR SDAP 401 or 445 may include some of functions below. The NR SDAP is not limited by the following functions and may perform various functions.
Transfer of user data (transfer of user plane data)
Mapping between a QoS flow and a data bearer for uplink and downlink (mapping between a QoS flow and a data radio bearer (DRB) for both DL and UL)
Marking a QoS flow ID in uplink and downlink (marking QoS flow ID in both DL and UL packets)
Mapping a reflective QoS flow to a data bearer with respect to UL SDAP PDUs (reflective QoS flow to DRB mapping for the UL SDAP PDUS)

Whether to use a header of the SDAP layer device, or whether to use a function of the SDAP layer device may be configured for the UE with respect to the SDAP layer device through an RRC message for each PDCP layer device, each bearer, or each logical channel. In a case where an SDAP header is configured, a non access stratum (NAS) QoS reflective configuration one-bit indicator (NAS reflective QoS) and an As QoS reflective configuration one-bit indicator (As reflective QoS) of the SDAP header may indicate the terminal to update or reconfigure mapping information relating to a QoS flow and a data bearer for uplink and downlink. The QoS information may be used as data processing priority, scheduling information, or the like, for smoothly supporting the service.

The main functions of the NR PDCP 405 or 440 may include some of functions below. The NR PDCP is not limited by the following functions and may perform various functions.
Header compression and decompression (ROHC only)
Transfer of user data
In-sequence delivery (In-sequencer delivery of upper layer PDUs)
Out-of-sequence delivery (Out-of-sequence delivery of upper layer PDUs)
Reordering (PDCP PDU reordering for reception)
Duplicate detection (Duplicate detection of lower layer SDUs)
Retransmission (Retransmission of PDCP SDUs)
Ciphering and deciphering
Timer-based SDU discard (Timer-based SDU discard in uplink)

The reordering of the NR PDCP device refers to a function of reordering PDCP PDU received from a lower layer in an order based on PDCP sequence numbers (SNs), and may include a function of transferring data to a higher layer according to a rearranged order, may include a function of directly transferring data without considering order, may include a function of rearranging order to record lost PDCP PDUs, may include a function of reporting the state of lost PDCP PDUs to a transmission side, or may include a function of requesting retransmission of lost PDCP PDUs.

The main functions of the NR RLC 410 or 435 may include some of functions below. The NR RLC is not limited by the following functions and may perform various functions.
Data transfer (Transfer of upper layer PDUs)
In-sequence delivery (In-sequence delivery of upper layer PDUs)
Out-of-sequence delivery (Out-of-sequence delivery of upper layer PDUs)
ARQ (Error correction through ARQ)
Concatenation, segmentation and reassembly (Concatenation, segmentation and reassembly of RLC SDUs)
Re-segmentation (Re-segmentation of RLC data PDUs)
Reordering (Reordering of RLC data PDUs)
Duplicate detection
Error detection (Protocol error detection)
RLC SDU discard
RLC re-establishment

The in-sequence delivery of the NR RLC device refers to a function of transferring RLC SDUs received from a lower layer to a higher layer in sequence, may include a function of, if one original RLC SDU is divided into several RLC SDUs and then the RLC SDUs are received, reassembling the several RLC SDUs and transferring the reassembled RLC SDUs, may include a function of rearranging received RLC PDUs with reference to RLC sequence numbers (SNs) or PDCP sequence numbers (SNs), may include a function of rearranging sequence to record lost RLC PDUs, may include a function of reporting the state of lost RLC PDUs to a transmission side, and may include a function of requesting retransmission of lost RLC PDUs.

The in-sequence delivery of the NR RLC device may include a function of, if there is a lost RLC SDU, sequentially transferring only RLC SDUs before the lost RLC SDU to a higher layer.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to the current, to a higher layer.

The in-sequence delivery of the NR RLC device may process RLC PDUs in a reception sequence (a sequence in which the RLC PDUs arrive, regardless of a sequence based on sequence numbers (out-of-sequence delivery)) and then transfer the processed RLC PDUs to the NR PDCP device.

In a case where the NR RLC device receives segments, the in-sequence delivery of the NR RLC device may receive segments stored in a buffer or to be received in the future, reconfigure the segments to be one whole RLC PDU, process the RLC PDU, and then transfer the processed RLC PDU to the NR PDCP device.

The NR RLC layer may not include a concatenation function, but the concatenation function may be performed in the NR MAC layer or replaced with a multiplexing function of the NR MAC layer.

The out-of-sequence delivery function of the NR RLC device refers to a function of immediately transferring RLC SDUs received from a lower layer, to an upper layer regardless of the sequence thereof, and may include a function of, if one original RLC SDU is divided into several RLC SDUs and then the RLC SDUs are received, reassembling the several RLC SDUs and transferring the reassembled RLC SDUs, and may include a function of storing an RLC sequence number (SN) or a PDCP sequence number (SN) of received RLC PDUs and arranging sequence to record lost RLC PDUs.

The NR MAC 415 or 430 may be connected to several NR RLC layer devices configured in a single UE, and the main functions of the NR MAC may include some of functions below. The NR MAC is not limited by the following functions and may perform various functions.
Mapping (mapping between logical channels and transport channels)
Multiplexing and demultiplexing (multiplexing/demultiplexing of MAC SDUs)
Scheduling information reporting
HARQ (error correction through HARQ)
Priority handling between logical channels (priority handling between logical channels of one UE)
Priority handling between UEs (priority handling between UEs by means of dynamic scheduling)
MBMS service identification
Transport format selection
Padding

An NR PHYl layer 420 or 425 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer. The NR PHY layer is not limited by these functions and may perform various functions.

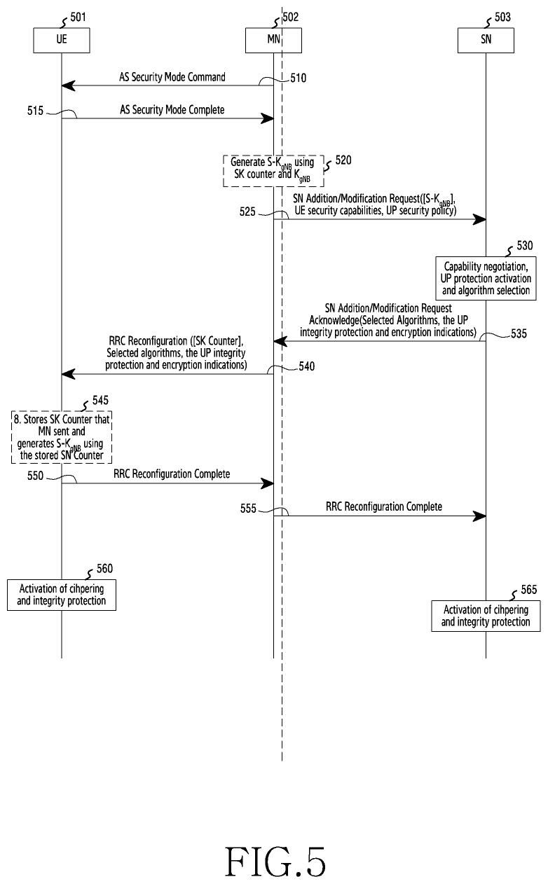

FIG. 5 is a diagram illustrating an operation of configuring a security key when dual connectivity (DC) is configured in an LTE system or an NR system according to an embodiment of the disclosure. FIG. 5 starts with a procedure in which a terminal and a base station (MN) are first connected, and then mainly describes a security key configuration for configuring DC.

Referring to FIG. 5, in operation 510, a base station (MN) 502 may transfer, to a terminal 501, an AS Security Mode command (SecurityModeCommand) for performing a security procedure by exchanging a security key and an algorithm for a security configuration applied to a subsequent RRC message and data.

TABLE 1

| | |
|---|---|
| SecurityModeCommand ::= | SEQUENCE { |
| rrc-TransactionIdentifier | RRC-TransactionIdentifier, |
| criticalExtensions | CHOICE { |
| securityModeCommand | SecurityModeCommand-IEs, |
| criticalExtensionsFuture | SEQUENCE { } |

```
    }
  }
```

| | |
|---|---|
| SecurityModeCommand-Ies ::= | SEQUENCE { |
| securityConfigSMC | SecurityConfigSMC, |
| lateNonCriticalExtension | OCTET STRING |

OPTIONAL,

| | |
|---|---|
| nonCriticalExtension | SEQUENCE{ } |

OPTIONAL
}

| | |
|---|---|
| SecurityConfigSMC ::= | SEQUENCE { |
| securityAlgorithmConfig | SecurityAlgorithmConfig, |

```
    ...
  }
```

In response to the AS security mode command in operation 510, the terminal 501 may transfer an AS security mode complete message (SecurityModeComplete) to the base station (MN) 502 in operation 515. This is an indication that the terminal has successfully received the AS Security Mode command and enabled AS security.

TABLE 2

| | |
|---|---|
| SecurityModeComplete ::= | SEQUENCE { |
| rrc-TransactionIdentifier | RRC-TransactionIdentifier, |
| criticalExtensions | CHOICE { |
| securityModeComplete | SecurityModeComplete-Ies, |
| criticalExtensionsFuture | SEQUENCE { } |

```
    }
  }
```

| | |
|---|---|
| SecurityModeComplete-Ies ::= | SEQUENCE { |
| lateNonCriticalExtension | OCTET STRING |

OPTIONAL,

| | |
|---|---|
| nonCriticalExtension | SEQUENCE{ } |

OPTIONAL
}

In operation 520, when it is determined, based on a channel measurement report from the terminal, that a DC configuration for the terminal is necessary, the base station (MN) 502 may prepare a DC configuration request for a neighboring base station. First, the base station (MN) 502 may determine a candidate base station and generate S-K_{gNB} that is an SN master key by applying an SK counter (sk-counter) used for generating an SN key, based on KgvB that is an MN master key currently used for security associated with the terminal.

In operation 525, the base station (MN) 502 may transfer an SN addition and modification request (SN addition/modification request) message to an SN base station 503 for which a DC configuration is requested. Via the SN addition and modification request message, S-K_{gNB} that is the SN master key to be used by the terminal in the SN, UE capability information, a user plane (UP) security policy (ciphering/integrity algorithm), or the like, may be transferred.

In operation 530, the SN base station 503 may perform UE capability negotiation with the MN, UP security activation, algorithm selection, and the like.

In operation 535, the SN base station 503 may transfer the security algorithm determined in operation 530, particularly, an integrity/ciphering algorithm selection result, to the MN via an SN addition and modification request acknowledgment (SN addition/modification request acknowledgment) message. Based on this, the MN and the SN may identify that S-K_{gNB} which is the SN master key transferred by the MN in operation 525 is to be used.

In operation 540, the MN base station 502 may transfer RRC configuration information including a security configuration-related parameter to the terminal by including the same in an RRCReconfiguration message. Via the RRCReconfiguration message, an SK counter (sk-counter) value, UP integrity, and a ciphering algorithm are transferred so that S-K_{gNB} that is the SN master key may be obtained based on KevB that is the MN master key.

### SK-Counter

The information element (IE) SK-Counter is a counter used upon initial configuration of SN security for NR-DC and NR-E-UTRA (NE)-DC, as well as upon refresh of S-K_{gNB} or S-K_{eNB} based on the current or newly derived K_{gNB} during RRC Resume or RRC Reconfiguration, as defined in TS 33.501 [11].

TABLE 3

-- ASN1START
-- TAG-SKCOUNTER-START
SK-Counter ::= INTEGER (0..65535)
-- TAG-SKCOUNTER-STOP
-- ASN1STOP

In operation 545, the terminal may generate S-K_{gNB} that is the SN master key by applying the received SK counter (sk-counter) value to K_{gNB} that is the MN master key, store the generated S-K_{gNB}, and then apply the same to a message associated with the SN.

In operation 550, the terminal may transfer, to the MN base station 502, an RRCReconfigurationComplete message indicating that the RRC configuration has been successfully received and applied.

In operation 555, the MN base station 502 may transfer, to the SN base station 503, the RRCReconfigurationComplete message received from the terminal. Subsequently, the terminal and the SN base station may enable a ciphering/integrity function by applying S-K_{gNB} that is the SN master key to the CP/UP messages used in the SN in operations 560 and 565, respectively.

In the following reference drawings and proposed embodiments of the disclosure, an improvement technique for a PSCell addition and change, particularly, a continuous conditional PSCell addition and change (CPC and CPA, CPAC) procedure may be considered. Proposals may be made for methods of, even after an SCG change is performed for a previously supported CPAC operation, maintaining a corresponding configuration and condition to enable a CPAC to be triggered continuously, without releasing a configuration on a candidate secondary node (SN) configured from the base station. In particular, considerations from a security perspective to support corresponding scenarios are mainly described.

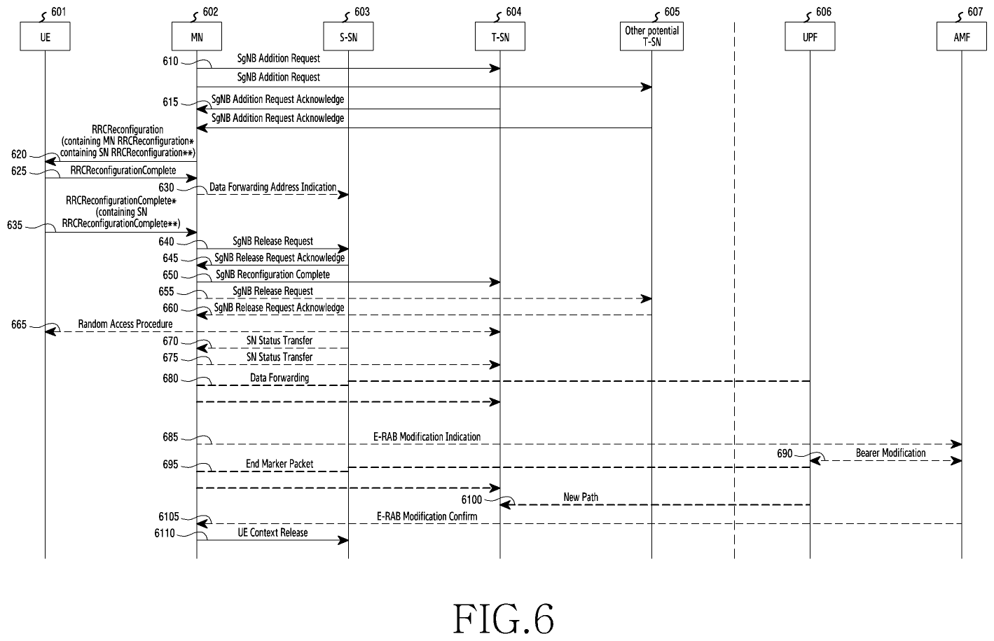

FIG. 6 is a diagram illustrating overall operations of performing a conditional PSCell change procedure in an LTE system or a NR system according to an embodiment of the disclosure. Although the drawing illustrates a conditional PSCell change procedure, a conditional PSCell addition operation is also mentioned and may be covered.

Referring to FIG. 6, an RRC connected terminal 601 may perform data transmission/reception and channel measurement/report operations according to a configuration of a connected master node (MN) 602/base station, and the MN base station 602 may identify, for the terminal, a need to change from a current source SN base station 603 to other SNs 604 and 605, so as to identify whether SN changes for the terminal to the SN nodes 604 and 605, which may be candidates, are possible. The corresponding procedure may be performed with the respective SN nodes 604 and 605 via a secondary gNB (sgNB) addition request in operation 610 and an sgNB addition request acknowledgment procedure in operation 615.

In operation 620, the MN base station 602 may transfer, to the terminal, CPC-related configurations (conditions for CPC and SCG-related RRC configurations) received from the candidate SNs 604 and 605 which have allowed SN addition and modification to the terminal in operation 610/615, by including the same in an RRC configuration message of the MN. In an EN-DC situation, a CPC-related configuration for the SN may be encapsulated in an RRCConnectionReconfiguration message, and in NE-DC and NR-DC situations, a CPC-related configuration for the SN may be encapsulated in and transferred via an RRCReconfiguration message. In the drawing, a description may be provided by assuming a case of NR-DC. For the SN CPC-related configuration included in the RRC configuration, up to 8 SN CPC configurations may be provided via ConditionalReconfiguration as follows. For reference, the number of SN CPC configurations may be the same as the maximum number of configurations related to MN CHO and SN CPCC, and the base station may configure up to 8 configurations based on both the MN CHO and SN CPAC. In the SN CPCC-related configuration, condReconfigId may denote an index of the SN CPCC configuration, and may include a condition (condExecutionCond) for SN CPC indicated by measId and condRRCReconfig including the SCG configuration applied after the terminal performs SN CPC. The condition (condExecutionCond) for SN CPC may include up to two trigger conditions, wherein one reference signal (RS) type and up to two different trigger quantities (e.g., reference signal received power (RSRP) and reference signal received quality (RSRQ), RSRP and signal to interference and noise ratio (SINR), or the like) may be provided as the condition.

TABLE 4

| | |
|---|---|
| ConditionalReconfiguration-r16 ::= | SEQUENCE { |
| attemptCondReconfig-r16 | ENUMERATED {true} |

OPTIONAL, -- Cond CHO

| | |
|---|---|
| condReconfigToRemoveList-r16 | CondReconfigToRemoveList-r16 |

OPTIONAL, -- Need N

| | |
|---|---|
| condReconfigToAddModList-r16 | CondReconfigToAddModList-r16 |

OPTIONAL, -- Need N
...

| | |
|---|---|
| CondReconfigToAddModList-r16 ::= | SEQUENCE (SIZE (1.. |

maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |
| CondReconfigExecCondSCG-r17) | OPTIONAL -- Need M |

```
  ]]
  }
```

| | |
|---|---|
| CondReconfigExecCondSCG-r17 ::= | SEQUENCE (SIZE (1..2)) OF MeasId |

In operation 625, the terminal may transfer an RRCReconfigurationComplete message to the MN base station 602 in response to the received RRC configuration (including configurations for the MN and SNs, particularly, a CPC-related configuration), and may indicate a data forwarding address to the source SN base station 603 in operation 630. The operation 630 may be omitted.

Then, when the CPC-related condition received from a specific SN is satisfied, the terminal may trigger an SN change procedure for the SN that satisfies the condition. For example, in operation 635, MN RRCReconfigurationComplete including an SN RRCReconfigurationComplete message for the SN for which the SN change procedure is triggered (the SN which satisfies the CPC condition) is generated and transferred to the MN base station 602. The MN base station 602 may transfer, in operation 640, an SgNB Release Request message for requesting SCG configuration release to the source SN base station 603, and in operation 645, the source SN base station 603 may respond to the request by transferring an SgNB Release Request acknowledgment message.

In operation 650, the MN base station 602 may transfer an SgNB Reconfiguration Complete message to the target SN base station 604 for which the CPC condition is satisfied, that is, to which the terminal performs the SN change, and may notify the SN change operation of the terminal.

In addition, in operation 655, the MN base station 602 may transfer, to the candidate SN base stations 605 to which the SN change is not performed, an SgNB release request message indicating release of the SCG configuration transferred to the terminal, and in operation 660, the respective candidate SN base stations 605 may transfer SgNB Release Request Acknowledgment in response to the SgNB Release Request message. Procedures of operations 655 and 660 may be omitted depending on implementations.

In operation 665, the terminal may perform a random-access procedure for the SN change with respect to the target SN for which CPC has been triggered. The random-access procedure for the SN change may be performed only when a security key needs to be updated, and may be omitted in other cases.

In operation 670, the MN base station 602 may receive a sequence number (SN) status from the source SN base station 603, and may transfer the received sequence number (SN) status to the target SN base station 604 in operation 675.

In operation 680, data from a UPF 606 may be transferred to the target SN base station 604. In addition, the MN base station 602 may transfer, in operation 685, a PDU session resource change indicator to an AMF 607, as an operation for path updating, the AMF 607 and the UPF 606 may perform a bearer modification procedure in operation 690, and the UPF 606 may transfer, in operation 695, a PDU packet including an end marker to the MN base station 602 so as to indicate a change of a previous bearer.

In operation 6100, the UPF 606 may indicate a new path to the target SN base station 604.

In operation 6105, the AMF 607 may transfer, to the MN base station 602, a PDU session resource change identification message indicating that the PDU session resource change has been completed, and in operation 6110, the MN base station 602 may indicate the source SN base station 603 to release terminal context.

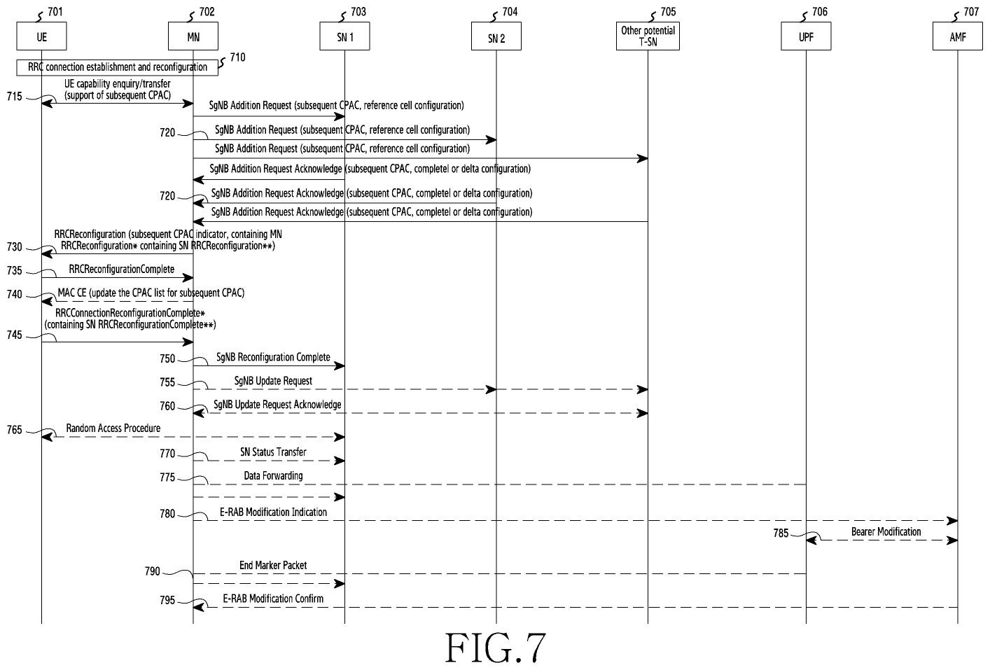

FIG. 7 is a diagram illustrating a part of overall operations of continuously performing a conditional PSCell addition and change procedure according to an embodiment of the disclosure. In the embodiment, in particular, a terminal concurrently receives configurations for CPA and CPC (condition for CPAC and SCG-related RRC configuration) from a base station in a state where DC is not configured for the terminal, and stores and manages configuration information for CPA and CPC. For example, even after adding or changing a PSCell, if the terminal does not additionally receive a separate RRC configuration from the base station, the received configuration may be maintained and applied as is.

Referring to FIG. 7, in operation 710, a terminal 701 may proceed with an RRC connection establishment procedure with a master node (MN) 702/base station and perform RRC configuration.

In operation 715, the terminal 701 and the MN base station 702 may identify capability of the terminal via a procedure of requesting and transferring UE capability via UE capability request (UECapabilityEnquiry) and UE capability information (UECapabilityInformation) messages. The UE capability may include an indicator indicating whether a continuous CPAC is supported. The UE capability may be transferred using one of a feature set methods for each terminal, each band, or each band combination, and may be transferred separately for CPA and CPC.

In operation 720, the MN base station 702 may identify a need to add an SN to the terminal 701, and identify with SN nodes 703, 704, and 705, which may be candidates, whether SN addition to the terminal is possible. The procedure of identifying whether SN addition to the terminal is possible may be performed via SgNB addition request in operation 720 and SgNB addition request acknowledgment in operation 725 with respect to the respective SN nodes. Content for identifying whether continuous CPAC is applicable may be added in the SgNB addition request acknowledgment procedure. For example, a continuous CPAC application identification indicator and an identification indicator may be included in the sgNB addition request and sgNB addition request acknowledgment. In addition, in operation 720, at least one of a reference cell and configuration information on the reference cell referenced during CPAC configuration may be transferred together. For example, separate reference cell configuration information and configuration information in the current source cell may be transferred, and if the reference cell configuration information is omitted, the current source cell configuration may be used as the reference cell configuration, or it may be determined that there is no reference cell configuration. Basically, the reference cell configuration is a basic configuration to enable delta configuration, and candidate SN cells may transfer configuration information to which delta configuration is applicable based on the reference cell configuration. As described above, when it is determined that there is no reference cell configuration, the candidate SN cells need to generate and transfer complete configuration information. In addition, the Xn message exchange procedure and RRC inter-node messages (CG-Config and CG-ConfigInfo) may include the continuous CPAC application identification indicator and identification indicator.

In operation 730, the MN base station 702 may include, in an RRC configuration message of the MN, the CPAC-related configuration (condition for CPAC and SCG-related RRC configuration) received from the candidate SNs, for which SN addition, particularly, CPAC has been allowed, in operation 720/725, and transfer the RRC configuration message to the terminal. In an EN-DC situation, the CPAC-related configuration for the SN may be encapsulated in an RRCConnectionReconfiguration message, and in NE-DC and NR-DC situations, the CPAC-related configuration for the SN may be encapsulated in and transferred via an RRCReconfiguration message. In the drawing, a description may be provided by assuming a case of NR-DC. When transferring the CPAC-related configuration (condition for SN CPAC, SCG configuration applied after performing SN CPAC, or the like) to the terminal, the base station may include, in a CPAC operation, an indicator (e.g., a subsequentCG-Change field below) indicating that a continuous CPAC operation is supported. The terminal having received the indicator indicating that a continuous CPAC operation is supported may keep/store the related CPAC configuration even after an SCG change. For example, when the terminal does not release the received CPAC configuration, and continuously identifies the stored CPAC conditions even after the SCG change, and if the conditions are satisfied, the terminal may trigger a CPC and perform a CPC operation from an existing PSCell to a target PSCell. The CPC operation from the existing PSCell to the target PSCell may continue until a separate release command for a continuous CPAC operation is received from the base station. There may be various methods of notifying that the base station supports a continuous CPAC operation, and the disclosure proposes the following methods.
1. Option 1: a method of notifying that continuous CPAC is supported and indicating the same to the terminal via an RRC message
1) Option 1-1: a method of notifying that continuous CPAC is supported commonly for CPAC configurations for all SNs provided by the base station
   Making a reference to the option 1-1 signaling method below (subsequentCG-Change-r18; ENUMERATE {enable})
   Performing signaling by extension in ConditionalReconfiguration-r16 IE, or indicating whether to enable a corresponding operation by introducing a new field in another IE in MN RRCReconfiguration
   The field may also be used to indicate whether to enable/disable a continuous CPAC operation, and the absence of corresponding field signaling may indicate that a CPAC operation is disabled.
   Signaling is possible in the form of ENUMERATE {activate, deactivate}
2) Option 1-2: a method of individually notifying each SN, to which a CPAC configuration provided by the base station is applied, that continuous CPAC is supported.
   A description will be provided in the option 1-2 signaling method below (subsequentCG-Change-r18; ENUMERATED {reserved, unreserved})
   Performing signaling by extension in CondReconfigToAddMod-r16 IE and indicating whether to enable a corresponding operation. For example, the terminal identifies whether continuous CPAC is applied for each CPAC configuration, and stores/keeps the related configuration accordingly (the configuration is not released even after an SCG change).
   For all CPAC configurations other than a corresponding field, separate signaling indicating whether to enable/disable a continuous CPAC operation may be used, wherein the signaling introduced in option 1-1 may be applied.

TABLE 5

| | |
|---|---|
| ConditionalReconfiguration-r16 ::= | SEQUENCE { |
| attemptCondReconfig-r16 | ENUMERATED {true} |

OPTIONAL, -- Cond CHO

| | |
|---|---|
| condReconfigToRemoveList-r16 | CondReconfigToRemoveList-r16 |

OPTIONAL, -- Need N

| | |
|---|---|
| condReconfigToAddModList-r16 | CondReconfigToAddModList-r16 |

```
OPTIONAL, -- Need N
  ...,
  // Option 1-1
```

| | |
|---|---|
| [[ subsequentCG-Change-r18 | ENUMERATED {enabled} |

OPTIONAL -- Need R
]]

| | |
|---|---|
| CondReconfigToAddModList-r16 ::= | SEQUENCE (SIZE (1.. |

maxNrofCondCells-r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |
| CondReconfigExecCondSCG-r17) | OPTIONAL -- Need M |

```
  ]],
  // Option 1-2
```

| | |
|---|---|
| [[ subsequentCG-Change-r18 | ENUMERATED {reserved, |
| unreserved} | OPTIONAL, -- Need R |

```
  ]]
  }
```

| | |
|---|---|
| CondReconfigExecCondSCG-r17 ::= | SEQUENCE (SIZE (1..2)) OF MeasId |

2. Option 2: Method of indicating a continuous CPAC operation and update of an applied configuration via MAC control element (CE) signaling
   Introducing a MAC CE having a new logical channel identifier (LCID) or eLCID
   Including a field indicating enabling/disabling of a continuous CPAC operation (a method of applying the field to all CPAC configurations or a method of applying the field to an individual CPAC configuration is possible)
   Additionally applicable to the RRC signaling method of option 1
   Used for signaling an update on a continuous CPAC operation by reducing latency and reducing signaling when there is a need to change whether to support an SN CPAC operation, based on an inter-node RRC message with an SN and negotiation via an Xn interface.

As described above, option 2 may be used in operation 740, and may be omitted when the RRC configuration is replaced and used (repetition of operation 730/735).

In operation 735, the terminal may transfer an RRCReconfigurationComplete message to the MN base station 702 in response to the received RRC configuration (including configurations for MN and SN, particularly, CPAC-related configuration), and then when the CPAC-related condition received from the specific SN (SN 1) 702 is satisfied, the terminal may trigger an SN addition procedure for the SN (SN 1) 702.

For example, in operation 745, MN RRCReconfigurationComplete including an SN RRCReconfigurationComplete message for the SN for which the SN addition procedure is triggered (the SN which satisfies the CPA condition) is generated and transferred to the MN base station 702.

In operation 750, the MN base station 702 may transfer an SgNB reconfiguration complete message to the SN base station 703 for which the CPA condition is satisfied, that is, to which the terminal performs SN addition, and may notify the SN addition operation of the terminal.

In addition, in operation 755, the MN base station 702 may perform a procedure of identifying validity of the CPAC configuration transferred to the terminal, with respect to the candidate SN base stations for which SN addition has not been performed. For example, in operation 755, the MN base station 702 may request whether the previously provided (continuous) CPAC configuration needs to be updated or is valid even after the SCG change. The message transmitted by the MN 702 in operation 755 may be an SgNB update request message or another Xn message, and may be an RRC inter-node message.

In operation 760, the respective candidate SNs may transfer an SgNB release request acknowledgment or RRC inter-node message including (continuous) CPAC configuration update information in response to the message transmitted by the MN 702 in operation 755. Procedures of operations 755 and 760 may be omitted depending on implementations. In addition, also in these operations, a complete configuration and a delta configuration for the CPAC configuration may be requested, and the CPAC configuration may be performed accordingly.

In operation 765, the terminal may perform a random-access procedure for SN addition to the SN for which CPA has been triggered. This operation is performed only when a security key needs to be updated, and may be omitted in other cases.

In operation 770, the MN base station 702 may transfer a sequence number (SN) status to the SN base station 703, and may perform a procedure of transferring data from a UPF 706 to the SN base station 703 in operation 775. In addition, the MN base station 702 may transfer, in operation 780, a PDU session resource change indicator to an AMF 707, as an operation for path updating, the AMF 707 and the UPF 706 may perform a bearer modification procedure in operation 785, and the UPF 706 may transfer, in operation 790, a PDU packet including an end marker to the MN base station 702 so as to indicate a change of a previous bearer. In operation 795, the AMF 707 may transfer, to the MN base station 702, a PDU session resource change identification message indicating that the PDU session resource change has been completed.

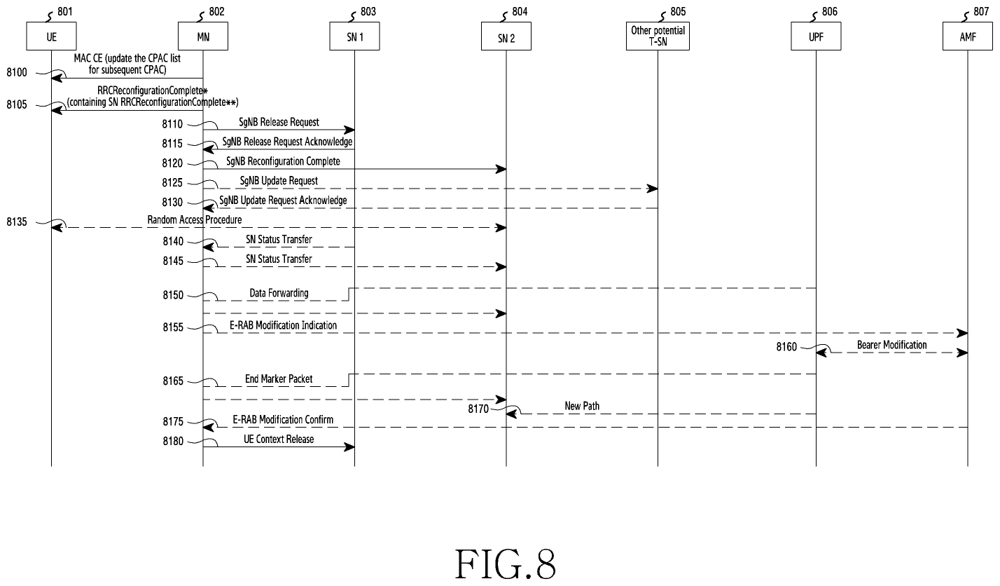

FIG. 8 is a diagram illustrating remaining parts of overall operations of continuously performing a conditional PSCell addition and change procedure according to an embodiment of the disclosure.

Referring to FIG. 8, as described above, a procedure of indicating an update for a continuous CPAC operation may be triggered at any time by identification between base stations, and for example, as in operation 8100, information on an SN to which a continuous CPAC operation is applied may be updated via a new MAC CE. Alternatively, explicit modification and release of a CPAC configuration is possible via an RRC message. In the corresponding operation, CPA and CPC configurations which are mainly described in the embodiments of the disclosure may be transferred simultaneously, and validity of the continuous CPA and CPC configurations may also be indicated in the MAC CE update.

Then, when the CPAC-related condition received from a specific SN is satisfied, a terminal 801 may trigger an SN change procedure for the SN. For example, in operation 8105, MN RRCReconfigurationComplete including an SN RRCReconfigurationComplete message for the SN (SN 2) 804 for which the SN change procedure is triggered (the SN which satisfies the CPAC condition) is generated and transferred to the MN base station 802. The MN base station 802 may transfer, in operation 8110, an SgNB release request message for requesting SCG configuration release to the source SN base station 803, and in operation 8115, the source SN base station 803 may respond to the request by transferring an SgNB release request acknowledgment message. In operation 8120, the MN base station 802 may transfer an SgNB reconfiguration complete message to the target SN base station (SN 2) 804 for which the CPAC condition is satisfied, that is, to which the terminal performs an SN change, and may notify the SN change operation of the terminal. In addition, in operation 8125, the MN base station 802 may perform a procedure of identifying validity of the CPAC configuration transferred to the terminal, with respect to the candidate SN base stations 805 for which the SN change has not been performed. For example, in operation 8125, the MN base station 802 may request whether the previously provided (continuous) CPAC configuration needs to be updated or is valid even after the SCG change. The message transmitted by the MN 802 in operation 8125 may be an SgNB update request message or another Xn message, and may be an RRC inter-node message. In operation 8130, the respective candidate SNs may transfer an SgNB release request acknowledgment or RRC inter-node message including (continuous) CPAC configuration update information in response to the message transmitted by the MN 802 in operation 8125. Procedures of operations 8125 and 8130 may be omitted depending on implementations. In these operations, a full configuration and a delta configuration for the CPAC configuration may be requested, and the CPAC configuration may be performed accordingly. In addition, continuous CPAC operations which may be repeatedly performed thereafter are omitted in the drawing, but the terminal may perform related operations (triggering CPC and performing CPC) by continuously applying the received CPAC configuration.

In operation 8135, the terminal may perform a random-access procedure for the SN change with respect to the target SN (SN 2) 804 for which CPC has been triggered. This operation is performed only when a security key needs to be updated, and may be omitted in other cases.

In operation 8140, the MN base station 802 may receive a sequence number (SN) status from the source SN base station 803, and may transfer the received sequence number (SN) status to the target SN base station 804 in operation 8145.

In operation 8150, data from the UPF 806 may be transferred to the target SN base station 804. In addition, the MN base station 802 may transfer, in operation 8155, a PDU session resource change indicator to an AMF 807, as an operation for path updating, the AMF 807 and the UPF 806 may perform a bearer modification procedure in operation 8160, and the UPF 806 may transfer, in operation 8165, a PDU packet including an end marker to the MN base station 802 so as to indicate a change of a previous bearer.

In operation 8170, the UPF 806 may indicate a new path to the target SN base station 804.

In operation 8175, the AMF 807 may transfer, to the MN base station 802, a PDU session resource change identification message indicating that the PDU session resource change has been completed, and in operation 8180, the MN base station 802 may indicate the source SN base station 803 to release terminal context.

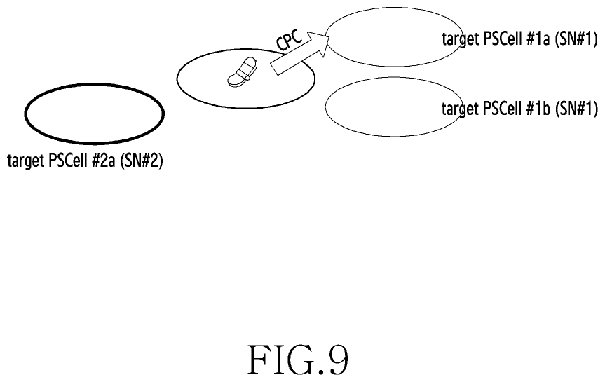

In a scenario proposed in the disclosure, during a continuous conditional PSCell addition and change procedure, a terminal, in particular, may maintain an RRC connection to the same PCell, store conditional configuration information for target PSCells, and then perform an additional change to a specific target PSCell according to a channel measurement result. After performing conditional configuration once, the terminal may continue to maintain conditional configuration information of candidate target PSCells and perform multiple conditional PSCell change procedures between the candidate target PSCells. The aforementioned procedure may be continued without a new RRC configuration being received from a network, that is, the conditional configuration information that has been configured once for the terminal and stored in the terminal may be used. For reference, the candidate target PSCells may be controlled by different SN nodes, but may be configured to be different PSCells within the same SN. In this situation, when performing a continuous conditional PSCell change to a candidate target PSCell considered in the disclosure, an operation of configuring and maintaining a security key should be improved. This will be described with reference to FIG. 9.

FIG. 9 is a diagram illustrating a scenario for improving an operation of configuring and maintaining a security key according to an embodiment of the disclosure.

Referring to FIG. 9, the following scenarios may be considered.
1. First continuous conditional PSCell change scenario (a case of changing back to a PSCell to which a change has been made once)
A. Operation 1: The terminal changes a PSCell to PSCell #1a controlled by SN #1 (performing a DC operation with PSCell #1a).
B. Operation 2: The terminal changes a PSCell to PSCell #2a controlled by SN #2 according to a channel measurement result (performing a DC operation with PSCell #2a).
C. Operation 3: The terminal changes a PSCell to PSCell #1a controlled by SN #1 according to a channel measurement result (performing a DC operation with PSCell #1a).
2. Second continuous conditional PSCell change scenario (a case of changing back to another PSCell in an SN to which a PSCell, to which a change has been made once, belongs)
A. Operation 1: The terminal changes a PSCell to PSCell #1a controlled by SN #1 (performing a DC operation with PSCell #1a).
B. Operation 2: The terminal changes a PSCell to PSCell #2a controlled by SN #2 according to a channel measurement result (performing a DC operation with PSCell #2a).
C. Operation 3: The terminal changes a PSCell to PSCell #1b controlled by SN #1 according to a channel measurement result (performing a DC operation with PSCell #1b).

A problem considered in the above scenarios is whether the same security key is applicable and usable for PSCells to which a conditional PSCell change has been made once, and the same security key should not be used on a node with a new RRC connection. Therefore, possible solutions for the above scenarios are as follows. In addition, in all embodiments of the disclosure, conditional PSCell configuration information may include a security key configuration (sk-counter) value. Detailed operations are described with reference to FIGS. 5, 6, and 7.
1. First method of configuring a security key for a continuous conditional PSCell change
   Once a conditional PSCell change has been performed (if a conditional PSCell is performed on a specific PSCell and a corresponding configuration is used), the PSCell to which a conditional PSCell change has been performed may be released/removed from the continuous conditional PSCell configuration.
   If there is a candidate target PSCell belonging to the same SN where the PSCell to which the conditional PSCell change has been performed is present, the candidate target PSCell may also be released/removed from the continuous conditional PSCell configuration. In other words, this is a case where a security key configuration (sk-counter) is configured in units of SNs.
   Performing security key configuration (sk-counter) in units of PSCells may cause restrictions on the network as follows.
      Performing security key configuration (sk-counter) differently for each candidate target PSCell (even if a candidate target PSCell belongs to the same SN)
      For this, configuration may be performed differently when a security key is configured via an Xn/F1 interface and via an inter-node message between base stations. Detailed procedures may be identified in the following embodiment.
      When a security key configuration (sk-counter) is used differently for each candidate target PSCell, even in a case where a conditional PSCell change has been performed once, the terminal may perform a continuous conditional PSCell change to a PSCell belonging to the same SN as that for a PSCell to which the conditional PSCell change has been performed.
2. Second method of configuring a security key for a continuous conditional PSCell change
   When a new security key configuration (sk-counter) is introduced and a conditional PSCell change has been performed once (if a conditional PSCell is performed on a specific PSCell and a corresponding configuration is used), the continuous conditional PSCell configuration for the PSCell to which the conditional PSCell change has been performed may be continuously stored and maintained.
   Implementation is possible via the following two methods.
      Option 2-1: Configuring multiple security keys (sk-counters/S-KgNBs) for candidate target PSCells, and performing configuration and management for each SN or each PSCell
   An MN and an SN generate and manage multiple security keys (sk-counter/S-K_{gNB}) (the MN generates multiple S-KgNBs based on a master key (K_{gNB}) of the MN and transfers the generated S-KgNBs to the SN (or candidate target PSCell))
   A security key management procedure is performed for each candidate PSCell or each candidate SN (SgNB security key/SN security key procedure)
   An MN and an SN performs negotiation and makes a determination on multiple security keys (the number of multiple available security keys (S-KgNBs) and a request and acknowledgment of an applied key are determined by requesting and responding to each other.) The procedure may be performed via an Xn/F1 interface and an inter-node RRC message between the MN and the SN.
   The terminal may receive a configuration related to a continuous conditional PSCell change from the MN for each target candidate cell, and corresponding configuration content may include a configuration including multiple new security keys (sk-counters).
   For example, a configuration, such as sk-counterList={sk-counter #1, sk-counter #2, . . . sk-counter #N}
   Here, N can be determined by the MN and the SN via a negotiation procedure, and may be configured for the terminal by determining the number of sk-counters in sk-counterList, also based on UE capability.
   The indicated sk-counterList is applied by overriding a previously signaled sk-counter value (that is, when newly signaled sk-counterList exists, an existing configuration is not used and the newly signaled sk-counterList is applied)
   The received sk-counterList is stored and managed in a terminal buffer, and later when a change is performed to a PSCell to which a conditional PSCell change has been performed or to another PSCell belonging to an SN where a conditional PSCell change has been performed, an sk-counter may be applied while increasing an index applied in the list.
   In a procedure of applying RRCReconfiguration when the terminal performs a conditional PSCell change, after applying the sk-counter, it is necessary to add a procedure of receiving and executing an RRCReconfiguration message.
   If a security key is managed for each SN, and different sk-counterList cannot be configured for candidate target PSCells, when a change is performed to another PSCell belonging to an SN where a conditional PSCell change has been performed, it is necessary, after applying the sk-counter, to add a procedure of receiving and executing an RRCReconfiguration message.
   First signaling method: Adding new signaling by using non-critical extension in CondReconfigToAddMod-r16

TABLE 6

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF |
| MeasId | OPTIONAL, -- Need M |
| condRRCReconfig-r16 | OCTET STRING (CONTAINING |
| RRCReconfiguration) | OPTIONAL, -- Cond condReconfigAdd |

```
    ...,
    [[
```

| | |
|---|---|
| condExecutionCondSCG-r17 | OCTET STRING (CONTAINING |
| CondReconfigExecCondSCG-r17) | OPTIONAL -- Need M |

```
    ]],
      [[
```

| | |
|---|---|
| sk-counterToAddModList-r18 | SK- |

```
counterToAddModList-r18
  OPTIONAL -- Need N
      ]]
  }
```

| | |
|---|---|
| SK-counterToAddModList-r18 | SEQUENCE (SIZE (1.. maxNrofSK- |

counter-r18)) SK-Counter

Second signaling method: Adding new signaling by using non-critical extension in the RRCReconfiguration message indicated by condRRCReconfig

TABLE 7

| | |
|---|---|
| RRCReconfiguration-v18xy-IEs ::= | SEQUENCE { |
| sk-counterToAddModList-r18 | SK-counterToAddModList-r18 |
| | OPTIONAL -- Need N |
| nonCriticalExtension | SEQUENCE { } |

OPTIONAL
}

| | |
|---|---|
| SK-counterToAddModList-r18 | SEQUENCE (SIZE (1.. maxNrofSK- |

counter-r18)) SK-Counter

The terminal and the network need to accurately identify the number of continuous conditional PSCell changes performed to a specific PSCell, particularly, the number of changes performed before a change to a corresponding PSCell is performed. For example, specific configuration values as shown below are stored, managed, and checked.
Terminal: a configuration index included in each PSCell for which conditional PSCell configuration had been performed, the number (N) of times of a continuous conditional PSCell change performed to a specific PSCell, and all sk-counterList and an sk-counter used by the terminal (for inference of an sk-counter available for next time)
Network: a terminal ID (cell radio network temporary identifier (C-RNTI) or a terminal ID capable of terminal disclosure), the number (N) of times of a continuous conditional PSCell change performed to a specific PSCell, and all sk-counterList and an sk-counter used by the terminal (for inference of an sk-counter available for next time)
Option 2-2: Security key configuration (sk-counter/S-K_{gNB}) is performed for candidate target PSCells as before, but whenever a conditional PSCell change is performed, a preconfigured sk-counter value may be increased according to a predetermined rule so as to update an sk-counter value. Configuration and management are performed for each SN or each PSCell.
The MN and the SN generate and manage multiple security keys (S-KgNBs) (The MN generates multiple S-KgNBs by increasing an sk-counter according to a rule predetermined for one sk-counter, based on a master key (K_{gNB}) of the MN) Multiple S-KgNBs are generated and transferred to the SN (or candidate target PSCell)
The multiple security keys (S-KgNBs) transferred to the SN by the MN correspond to the master key of the MN.
A security key management procedure is performed for each candidate PSCell or each candidate SN (SgNB security key/SN security key procedure)
An MN and an SN performs negotiation and makes a determination on multiple security keys (the number of multiple available security keys (S-KgNBs) and a request and acknowledgment of an applied key are determined by requesting and responding to each other.) The procedure may be performed via an Xn/F1 interface and an inter-node RRC message between the MN and the SN.
sk-counter generation rules
For example, a single sk-counter is configured in an initial candidate target PSCell configuration, and then whenever the number of continuous conditional PSCell changes performed for a corresponding PSCell increases, “+1” is applied and an sk-counter+1 value is used for a security key.
Alternatively, new rules and functions applicable to update an sk-counter value may be configured and applied (this may be a basic increase method, such as “+M”, or may be a rule to which a function enabling mathematical randomization is applied). In addition, configurations or result values required to apply these new rules may be provided as configurations to the terminal.
The received sk-counter is stored and managed in a terminal buffer, and later when a change is performed to a PSCell to which a conditional PSCell change has been performed or to another PSCell belonging to an SN where a conditional PSCell change has been performed, new rules are applied.
In a procedure of applying RRCReconfiguration when the terminal performs a conditional PSCell change, after applying the sk-counter, it is necessary to add a procedure of receiving and executing an RRCReconfiguration message.
If a security key is managed for each SN, and different sk-counters cannot be configured for candidate target PSCells, when a change is performed to another PSCell belonging to an SN where a conditional PSCell change has been performed, it is necessary, after applying the sk-counter, to add a procedure of receiving and executing an RRCReconfiguration message.
The terminal and the network need to accurately identify the number of continuous conditional PSCell changes performed to a specific PSCell, particularly, the number of changes performed before a change to a corresponding PSCell is performed. For example, specific configuration values as shown below are stored, managed, and checked.
Terminal: a configuration index included in each PSCell for which conditional PSCell configuration had been performed, the number (N) of times of a continuous conditional PSCell change performed to a specific PSCell, and all sk-counterList and an sk-counter used by the terminal (for inference of an sk-counter available for next time)
Network: a terminal ID (C-RNTI or a terminal ID capable of terminal specification), the number (N) of times of a continuous conditional PSCell change performed to a specific PSCell, and all sk-counterList and an sk-counter used by the terminal (for inference of an sk-counter available for next time)

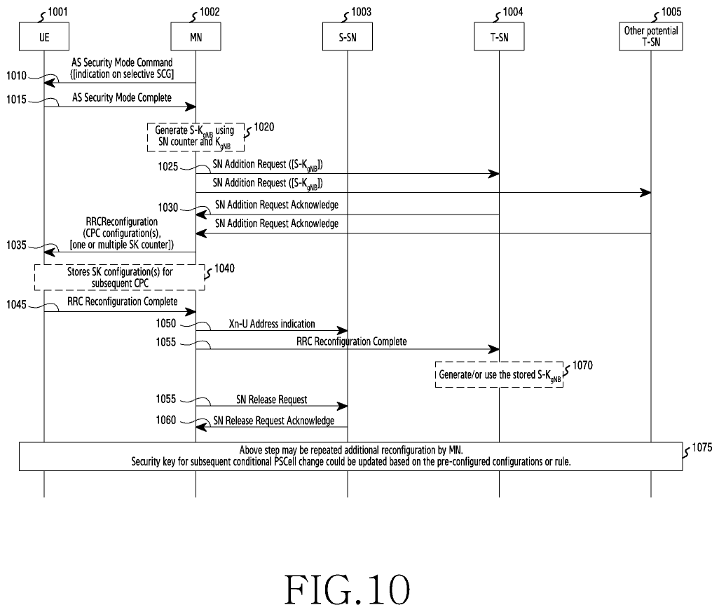

Hereinafter, in FIG. 10, descriptions will be provided for a method of configuring a security key for a continuous conditional PSCell change, particularly, overall procedures to which the second method of configuring a security key for a continuous conditional PSCell change is applied. The detailed features of the disclosure have all been provided in the descriptions above, and in FIG. 10 below, a description will be provided for how the proposed disclosure is applied in the procedures.

FIG. 10 is a diagram illustrating a security configuration procedure applied to a candidate PSCell in a continuous conditional PSCell addition and change procedure according to an embodiment of the disclosure.

Referring to FIG. 10, in operation 1010, a base station (MN) 1002 may transfer, to a terminal 1001, an AS security mode command (SecurityModeCommand) for performing a security procedure by exchanging a security key and an algorithm for a security configuration applied to a subsequent RRC message and data. In operation 1010, an indicator indicating that a continuous conditional PSCell change may be configured may be included. Alternatively, in a previous operation, based on UE capability information, it may be identified and indicated that a corresponding function may be configured for the terminal. Here, the indicator indicating that a continuous conditional PSCell change may be configured may be included in RRCReconfiguration rather than in the AS security mode command (SecurityModeCommand).

In response to the AS security mode command in operation 1010, the terminal 1001 may transfer an AS security mode complete message (SecurityModeComplete) to the base station (MN) 1002 in operation 1015. This is an indication that the terminal has successfully received the AS Security Mode command and enabled AS security.

In operation 1020, when it is determined, based on a channel measurement report from the terminal, that a DC configuration for the terminal is necessary, the base station (MN) 1002 may prepare a DC configuration request for a neighboring base station. In particular, when a continuous conditional PSCell change is supported according to UE capability, and if the terminal requests a continuous conditional PSCell change via a new procedure (request via an RRC message or request via a MAC CE), a candidate target base station may be determined, and multiple S-K_{gNB}s which are SN master keys may be generated by applying multiple SK counters (sk-counters) used for SN key generation to support the continuous conditional PSCell change, based on a K_{gNB} that is an MN master key used for security with respect to the terminal in the current MN. Reference is made to the descriptions above for operations of configuring multiple security keys to support a continuous conditional PSCell change.

In operation 1025, the base station (MN) 1002 may transfer an SN addition and modification request (SN addition/modification request) message to a candidate SN base station 1004/1005 for which a conditional PSCell change configuration is requested. Via the SN addition and modification request message, S-K_{gNB}s which are multiple SN master keys to be used by the terminal in SNs, UE capability information, a user plane (UP) security policy (ciphering/integrity algorithm), or the like, may be transferred. In addition, in operation 1025, the number (N) of continuous conditional PSCell changes which can be performed to the candidate target PSCells may be additionally transferred. In operation 1030, the candidate SN base station 1004/1005 may perform UE capability negotiation with the MN, UP security activation, algorithm selection, and the like. In addition, the SN base station 1004/1005 may adjust values via negotiation with respect to a value for the S-K_{gNB}S which are multiple SN master keys provided from the MN and a value for the number (N) of continuous conditional PSCell changes which can be performed to the candidate target PSCells. An SN base station 1003 may transfer the security algorithm determined in operation 1030, particularly, an integrity/ciphering algorithm selection result, to the MN via an SN addition and modification request acknowledgment (SN addition/modification request acknowledgment) message. Based on this, the MN and the SN may identify that S-K_{gNB} which is the SN master key transferred by the MN in operation 1025 is to be used.

In operation 1035, the MN base station 1002 may transfer RRC configuration information including a security configuration-related parameter to the terminal by including the same in an RRCReconfiguration message. The RRCReconfiguration message is used to transfer a UP integrity and ciphering algorithm and one SK counter (sk-counter) value which enables multiple SK counters to be applied whenever a conditional PSCell change is performed, by applying a new rule for multiple SK counter (sk-counter) values or security keys, so that S-K_{gNB}s which are the SN master keys are obtainable based on KgvB that is the MN master key.

In operation 1040, the terminal may generate (multiple) S-K_{gNB}S which are the SN master keys by applying the received (multiple) SK counter (sk-counter) values to K_{gNB} that is the MN master key, storing the generated S-K_{gNB}s, and then applying the same to messages associated with the SN. In operation 1045, the terminal may transfer, to the MN base station 1002, an RRCReconfigurationComplete message indicating that the RRC configuration has been successfully received and applied. In operation 1050, the MN may notify the source SN that CPC information has been configured for the terminal (UE), via an Xn-U Address Indication procedure. In operation 1055, the MN base station 1002 may transfer, to the target SN base station 1004, the RRCReconfigurationComplete message received from the terminal. The target SN base station 1004 which has received the message may use S-K_{gNB} that is the SN master key determined and stored in operations 1025 and 1030, and apply the same to the terminal. If S-K_{gNB} that is the SN master key does not exist in the corresponding operation, a procedure to generate S-K_{gNB} may be added in operation 1070. Subsequently, the terminal and the SN base station may enable a ciphering/integrity function by applying S-K_{gNB} that is the SN master key to the CP/UP messages used in the SN.

In operation 1060, the MN base station 1002 may notify the source SN base station 1003 that a DC connection has been released and transfers an SN Release Request message for requesting release of terminal context, and in operation 1065, the source SN base station 1003 may transfer an SN Release Request Acknowledgment message to the MN base station 1002 and release the terminal context.

In operation 1075, the terminal may continue to perform the continuous conditional PSCell change operation, that is, the CPC configuration configured in operation 1035 may be stored and used continuously. In this case, the security key-related configuration may also be stored and applied to a subsequent continuous conditional PSCell change operation. For example, for a security key, a preconfigured sk-counter value or an sk-counter value determined according to a predetermined rule may be applied when a change is performed to the same PSCell or to another PSCell belonging to the same SN as that for a PSCell to which a conditional PSCell change has been performed, according to the methods described above.

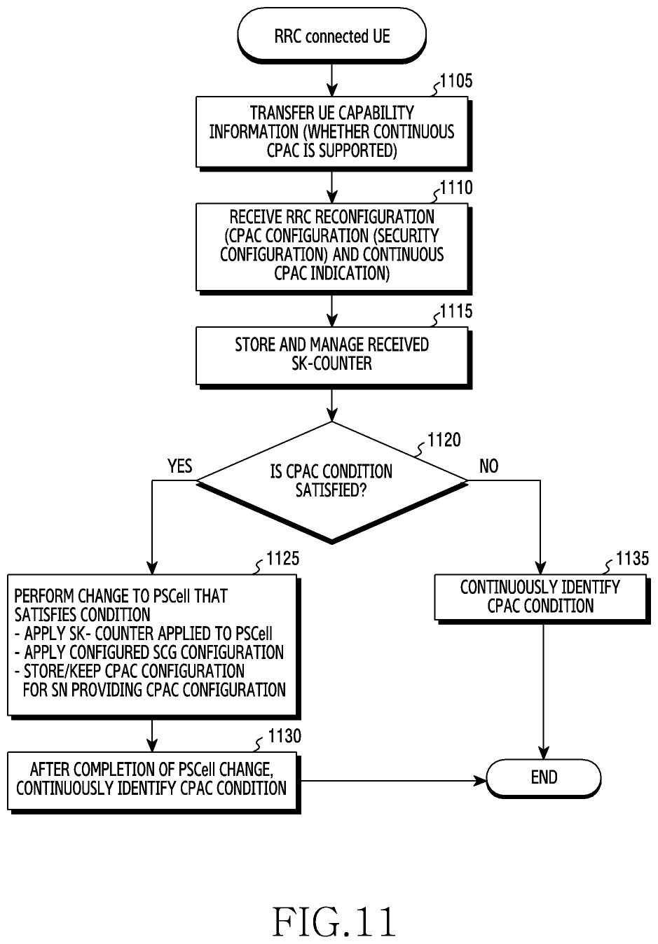

FIG. 11 is a diagram specifying a terminal operation when conditional PSCell addition and changes are continuously applied, as a terminal operation applied to embodiments according to an embodiment of the disclosure.

Referring to FIG. 11, in operation 1105, a terminal may transfer UE capability to a base station via a UE capability information (UECapabilityInformation) message in response to a request (UECapabilityEnquiry) of the base station. The UE capability may include an indicator indicating whether a continuous CPAC is supported. The UE capability may be transferred using one of a feature set methods for each terminal, each band, or each band combination, and may be transferred separately for CPA and CPC.

In operation 1110, the terminal may receive an RRC configuration from the base station, and the configuration may provide a basic configuration for data transmission and reception. In addition, the RRC configuration may include a CPAC configuration for multiple SNs/PSCells and an indicator indicating that a continuous CPAC is applied. The received CPAC configuration may be transferred by applying of a delta configuration to a reference cell and a reference cell configuration, in which case, the corresponding configuration may be decoded based on the reference cell configuration so that the entire cell configuration may be generated, stored, and managed. Alternatively, in this operation, the received configuration may be stored and managed as it is, and when a CPAC is actually triggered, a target cell configuration may be applied by performing decoding based on the reference cell configuration.

In operation 1115, the terminal may store the security keys for the conditional PSCell change, particularly, sk-counter value(s), which are received from the base station, and manage the same for subsequent connections. Reference is made to the descriptions above for a method of configuring, storing, and managing security keys for a conditional PSCell change.

When the RRC configuration is received in operation 1120, the terminal may continuously identify CPAC triggering conditions included in the CPAC configuration, and if the conditions are satisfied, the terminal may add a PSCell that satisfies the conditions or may perform a change to the PSCell, in operation 1125. First, the security key applied to the target PSCell, particularly, sk-counter, is applied, SCG configuration information provided in the CPAC configuration is applied, and when random access is required for the PSCell, random access is performed and uplink synchronization is performed. For example, the terminal may perform an operation for the PSCell change and additionally store/keep the CPAC configuration for the SN, which provides the CPAC configuration. The storing/keeping of the CPAC-related configuration for the SN, which provides the CPAC configuration, may be updated according to the RRC configuration provided in operation 1110. For example, the update may be performed according to most recently provided information.

In operation 1130, after completion of the change to the target PSCell, the terminal may continuously identify the channel measurement value and the CPAC conditions and perform the CPAC operation, based on the stored CPAC configuration for the SN supporting the continuous CPAC operation. Thereafter, the terminal may perform operations after operation 1110 or operation 1115 according to base station signaling. For example, the configuration for the conditional PSCell change may be updated or released with a new RRC configuration, and when there is no such RRC configuration update, a conditional PSCell change identification operation, which is an operation after operation 1120, may be performed. As described above, in this operation, the configuration for the conditional PSCell change stored in the terminal, particularly, the security key-related configuration, may be kept.

If the CPAC conditions are not satisfied in operation 1120, the terminal may continue to perform the CPAC identification operation in operation 1135.

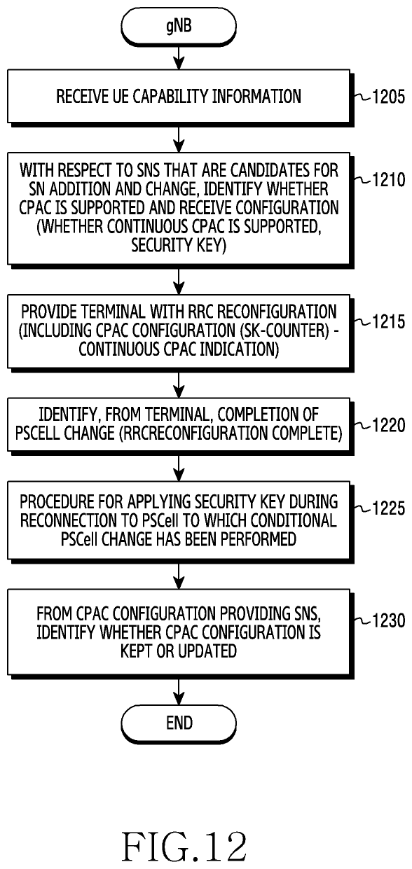

FIG. 12 is a diagram specifying a base station operation when conditional PSCell addition and changes are continuously applied, as a base station operation according to an embodiment of the disclosure.

Referring to FIG. 12, in operation 1205, a base station may transfer a UE capability request (UECapabilityEnquiry) message to a terminal to acquire UE capability, and accordingly receive the UE capability via a UE capability information (UECapabilityInformation) message. The UE capability may include an indicator indicating whether the terminal supports a continuous CPAC. The UE capability may be transferred using one of a feature set methods for each terminal, each band, or each band combination, and may be transferred separately for CPA and CPC. The base station may identify the UE capability, and then determine whether to indicate a continuous CPAC operation via RRC configuration.

In operation 1210, the base station may identify whether CPAC is supported and may perform negotiation for a related configuration, with respect to SNs which are candidates for SN addition and change. In this operation, whether respective SNs support a continuous CPAC is identified, and based on reference cell configuration information, CPAC configurations for the CPAC candidate SNs may be received based on a delta configuration. Alternatively, the CPAC configurations may be received based on a complete configuration. In addition, an indicator indicating this may be added. In addition, the disclosure may include a method in which, in order to configure multiple security keys enabling a continuous conditional PSCell change in corresponding operations, an MN and an SN determine the multiple security keys and the number of the keys via negotiation.

Based on this, in operation 1215, the CPAC-related configuration may be transferred to the terminal via RRC reconfiguration. For example, an indicator indicating a continuous CPAC operation according to configurations provided by respective SNs may be provided to the terminal along with the CPAC configuration. The terminal may be provided with a single sk-counter or a list including multiple sk-counters in relation to multiple security key configurations.

In operation 1220, the base station may receive an RRCReconfigurationComplete message from the terminal in response to the RRC reconfiguration having provided the SN configuration (CPAC configuration) (receiving an SN RRC complete message included in the MN RRC message), and may identify that the PSCell change has been completed.

In operation 1225, as a procedure for applying the security key during reconnection to the PSCell to which the conditional PSCell change has been performed, an operation of storing and managing the preconfigured and defined security key may be added.

In operation 1230, with respect to the SNs having provided the CPAC configuration, whether the (continuous) CPAC configuration is kept and updated may be identified. After negotiation with SN nodes in operation 1230, if the (continuous) CPAC configuration is updated, the base station may perform corresponding operation by providing RRC configuration again. In addition, since there may be an update for a continuous CPAC procedure at any time due to the operation of the base station below, the procedures of operations 1210 to 1230 may be re-performed via acknowledgment procedures between the base stations.

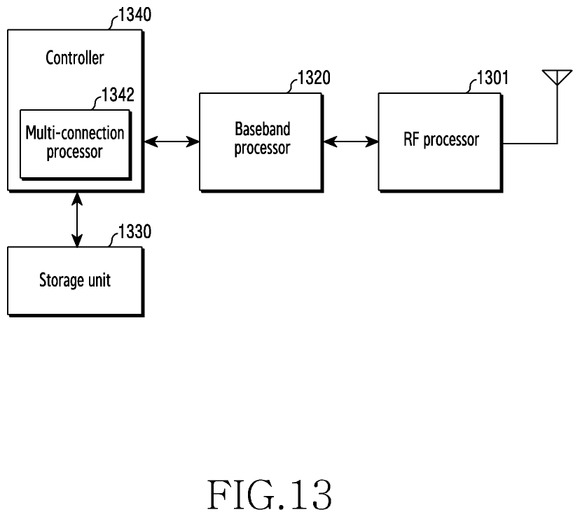

FIG. 13 is a block diagram illustrating an internal structure of a terminal according to an embodiment of the disclosure.

Referring to FIG. 13, a terminal may include a radio frequency (RF) processor 1301, a baseband processor 1320, a storage unit 1330, and a controller 1340.

The RF processor 1310 may perform a function for signal transmission and reception via a wireless channel, such as signal band transform and amplification. For example, the RF processor 1310 may up-convert a baseband signal provided from the baseband processor 1320 into an RF band signal, transmit the converted RF band signal via an antenna, and then down-convert the RF band signal received via the antenna into a baseband signal. For example, the RF processor 1310 may include a transmission filter, a reception filter, an amplifier, a mixer, an oscillator, a digital-to-analog converter (DAC), an analog-to-digital converter (ADC), and the like. In the drawing, only one antenna is illustrated, but the terminal may have multiple antennas. In addition, the RF processor 1310 may include multiple RF chains. Furthermore, the RF processor 1310 may perform beamforming. For beamforming, the RF processor 1310 may adjust a phase and a magnitude of each of signals transmitted and received via multiple antennas or antenna elements. In addition, the RF processor may perform MIMO, and may receive multiple layers when performing MIMO operations.

The baseband processor 1320 may perform a function of conversion between a baseband signal and a bitstream according to a physical layer specification of the system. For example, during data transmission, the baseband processor 1320 may generate complex symbols by encoding and modulating a transmission bitstream. In addition, during data reception, the baseband processor 1320 may reconstruct a reception bitstream via demodulation and decoding of a baseband signal provided from the RF processor 1310. For example, when conforming to an orthogonal frequency division multiplexing (OFDM) scheme, during data transmission, the baseband processor 1320 may generate complex symbols by encoding and modulating a transmission bitstream, map the complex symbols to sub-carriers, and then configure OFDM symbols via an inverse fast Fourier transform (IFFT) operation and cyclic prefix (CP) insertion. In addition, during data reception, the baseband processor 1320 may divide the baseband signal provided from the RF processor 1310 in units of OFDM symbols, reconstruct the signals mapped to the sub-carriers via a fast Fourier transform (FFT) operation, and then reconstruct the reception bitstream via demodulation and decoding.

The baseband processor 1320 and the RF processor 1310 may transmit and receive signals as described above. Accordingly, the baseband processor 1320 and the RF processor 1310 may be referred to as a transmitter, a receiver, a transceiver, or a communication unit. Furthermore, at least one of the baseband processor 1320 and the RF processor 1310 may include multiple communication modules to support multiple different radio access technologies. In addition, at least one of the baseband processor 11-20 and the RF processor 11-10 may include different communication modules to process signals of different frequency bands. For example, the different radio access technologies may include a wireless local area network (LAN) (e.g., IEEE 802.11), a cellular network (e.g., LTE), and the like. In addition, the different frequency bands may include a super-high frequency (SHF) (e.g., 2.NRHz, NRhz) band, and a millimeter wave (e.g., 60 GHZ) band.

The storage unit 1330 may store data, such as a basic program, an application program, configuration information, and the like for operation of the terminal. Particularly, the storage unit 1330 may store information on a second access node that performs wireless communication using a second radio access technology. In addition, the storage unit 1330 may provide stored data in response to a request of the controller 1340.

The controller 1340 may control overall operations of the terminal. For example, the controller 1340 may transmit and receive signals via the baseband processor 1320 and the RF processor 1310. In addition, the controller 1340 records and reads data in the storage unit 1340. To this end, the controller 1340 may include at least one processor. For example, the controller 1340 may include a communication processor (CP) configured to perform control for communication, and an application processor (AP) configured to control a higher layer, such as an application program. In addition, the controller 1340 may further include a multi-connection processor 1342 configured to support multiple connections.

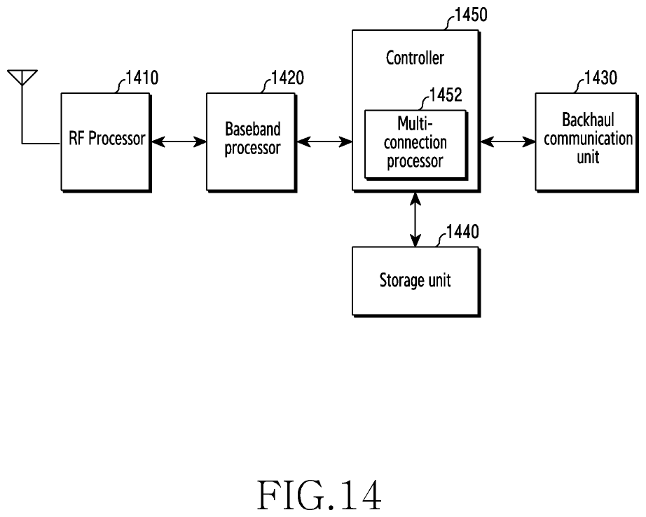

FIG. 14 is a block diagram illustrating a configuration of a base station according to an embodiment of the disclosure.

Referring to FIG. 14, a base station may include an RF processor 1410, a baseband processor 1420, a backhaul communication unit 1430, a storage unit 1440, and a controller 1450.

The RF processor 1410 may perform a function for signal transmission and reception via a wireless channel, such as signal band transform and amplification. For example, the RF processor 1410 may up-convert a baseband signal provided from the baseband processor 1420 into an RF band signal, transmit the converted RF band signal via an antenna, and then down-convert the RF band signal received via the antenna into a baseband signal. For example, the RF processor 1410 may include a transmission filter, a reception filter, an amplifier, a mixer, an oscillator, a DAC, an ADC, and the like. In FIG. 14, only one antenna is illustrated, but a first access node may include multiple antennas. In addition, the RF processor 1410 may include multiple RF chains. Furthermore, the RF processor 1410 may perform beamforming. For beamforming, the RF processor 1410 may adjust a phase and a magnitude of each of signals transmitted and received via multiple antennas or antenna elements. The RF processor may perform downlink MIMO operations by transmitting one or more layers.

The baseband processor 1420 may perform a function of conversion between a baseband signal and a bitstream according to a physical layer specification of a first radio access technology. For example, during data transmission, the baseband processor 1420 may generate complex symbols by encoding and modulating a transmission bitstream. In addition, during data reception, the baseband processor 1420 may reconstruct a reception bitstream via demodulation and decoding of a baseband signal provided from the RF processor 1410. For example, when conforming to an OFDM scheme, during data transmission, the baseband processor 1420 may generate complex symbols by encoding and modulating a transmission bitstream, map the complex symbols to sub-carriers, and then configure OFDM symbols via an IFFT operation and CP insertion. In addition, during data reception, the baseband processor 1420 may divide the baseband signal provided from the RF processor 1410 in units of OFDM symbols, reconstruct the signals mapped to the sub-carriers via an FFT operation, and then reconstruct the reception bitstream via demodulation and decoding. The baseband processor 1420 and the RF processor 1410 may transmit and receive signals as described above. Accordingly, the baseband processor 1420 and the RF processor 1410 may be referred to as a transmitter, a receiver, a transceiver, a communication unit, or a wireless communication unit.

The backhaul communication unit 1430 may provide an interface to perform communication with other nodes within a network. For example, the backhaul communication unit 1430 may convert, into a physical signal, a bitstream transmitted from a main base station to another node, for example, an auxiliary base station and a core network, and may convert a physical signal received from the another node into a bitstream.

The storage unit 1440 may store data, such as a basic program, an application program, configuration information, and the like for operation of the base station. Particularly, the storage unit 1440 may store information on a bearer assigned to a connected terminal, a measurement result reported from the connected terminal, and the like. In addition, the storage unit 1440 may store information serving as a criterion for determining whether to provide a terminal with multiple connections or to suspend multiple connections. In addition, the storage unit 1440 may provide stored data in response to a request of the controller 1450.

The controller 1450 may control overall operations of the main base station. For example, the controller 1450 may transmit and receive signals via the baseband processor 1420 and the RF processor 1410 or via the backhaul communication unit 1430. In addition, the controller 1450 records and reads data in the storage unit 1440. To this end, the controller 1450 may include at least one processor. In addition, the controller 1450 may further include a multi-connection processor 1452 configured to support multiple connections.

Methods disclosed in the claims and/or methods according to the embodiments described in the disclosure may be implemented by hardware, software, or a combination of hardware and software.

When the methods are implemented by software, a computer-readable storage medium for storing one or more programs (software modules) may be provided.

The one or more programs stored in the computer-readable storage medium may be configured for execution by one or more processors within the electronic device.

The at least one program may include instructions that cause the electronic device to perform the methods according to various embodiments of the disclosure as defined by the appended claims and/or disclosed herein.

The programs (software modules or software) may be stored in non-volatile memories including random access memory and flash memory, read only memory (ROM), electrically erasable programmable read only memory (EEPROM), a magnetic disc storage device, compact disc-ROM (CD-ROM), digital versatile discs (DVDs), or other type optical storage devices, or a magnetic cassette. Alternatively, any combination of some or all of them may form memory in which the program is stored. Furthermore, a plurality of such memories may be included in the electronic device.

In addition, the programs may be stored in an attachable storage device which may access the electronic device through communication networks, such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the drawings in which methods of the disclosure are described, the order of the description does not always correspond to the order in which operations of each method are performed, and the order relationship between the operations may be changed or the operations may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential features of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a wireless communication system, the method comprising:
receiving, from a master node (MN), configuration information associated with subsequent conditional primary secondary cell group cell (PSCell) addition or change (SCPAC), the configuration information includes sk-counter list including a plurality of sk-counters; and
executing the SCPAC for a first PSCell associated with a secondary node based on the configuration information,
wherein a first security key for the secondary node is generated based on a first sk-counter among the plurality of sk-counters.

2. The method of claim 1, wherein the sk-counter list including the plurality of sk-counters is for the secondary node associated with the first PSCell.

3. The method of claim 1, further comprising:
executing the SCPAC for a second PSCell associated with the secondary node based on the configuration information,
wherein a second security key for the secondary node is generated based on a second sk-counter which is next listed to the first sk-counter among the plurality of sk-counters.

4. The method of claim 3, wherein the first sk-counter is a sk-counter listed first within the sk-counter list including the plurality of sk-counters.

5. The method of claim 3, wherein the SCPAC for the second PSCell is a SCPAC from a third PSCell associated with another secondary node to the second PSCell associated with the secondary node.

6. The method of claim 1, wherein the sk-counter list is stored in the UE by replacing a previous sk-counter list which is for the secondary node.

7. The method of claim 6,
wherein in case that the previous sk-counter list which is for the secondary node is not stored in the UE, and
wherein the sk-counter list is stored in the UE as a sk-counter list for the secondary node.

8. The method of claim 1, wherein the SCPAC is an inter-secondary node SCPAC.

9. A user equipment (UE) in a wireless communication system, the UE comprising:
a transceiver; and
a controller coupled with the transceiver and configured to:
receive, from a master node (MN), configuration information associated with subsequent conditional primary secondary cell group cell (PSCell) addition or change (SCPAC), the configuration information includes sk-counter list including a plurality of sk-counters, and
execute the SCPAC for a first PSCell associated with a secondary node based on the configuration information,
wherein a first security key for the secondary node is generated based on a first sk-counter among the plurality of sk-counters.

10. The UE of claim 9, wherein the sk-counter list including the plurality of sk-counters is for the secondary node associated with the first PSCell.

11. The UE of claim 9,
wherein the controller is further configured to:
execute the SCPAC for a second PSCell associated with the secondary node based on the configuration information, and
wherein a second security key for the secondary node is generated based on a second sk-counter which is next listed to the first sk-counter among the plurality of sk-counters.

12. The UE of claim 11, wherein the first sk-counter is a sk-counter listed first within the sk-counter list including the plurality of sk-counters.

13. The UE of claim 11, wherein the SCPAC for the second PSCell is a SCPAC from a third PSCell associated with another secondary node to the second PSCell associated with the secondary node.

14. The UE of claim 9, wherein the sk-counter list is stored in the UE by replacing a previous sk-counter list which is for the secondary node.

15. The UE of claim 14,
wherein in case that the previous sk-counter list which is for the secondary node is not stored in the UE, and
wherein the sk-counter list is stored in the UE as a sk-counter list for the secondary node.

16. The UE of claim 9, wherein the SCPAC is an inter-secondary node SCPAC.
